(19) United States
(12) Patent Application Publication
(10) Pub. No.: US 2026/0196238 A1
(43) Pub. Date: Jul. 9, 2026

(54) Targeted Audio Neutralization Using Predictive Modeling

(71) Applicant: Bank of America Corporation, Charlotte, NC (US)

(72) Inventors: Jack Bishop, Evanston, IL (US); Adam B. Richman, Charlotte, NC (US); Jason Starin, Huntersville, NC (US); Ryan Muzzo, Saint Charles, IL (US); Nathaniel Clark, Wheaton, IL (US)

(21) Appl. No.: 19/014,530

(22) Filed: Jan. 9, 2025

(51) Int. Cl. G10L 25/18; G10L 15/02

(52) U.S. Cl. CPC G10L 25/18; G10L 15/02

(57) ABSTRACT

Systems and methods are disclosed for preventing unauthorized audio capture by neutralizing electronic personal digital assistants in real-time using predictive modeling. The system captures audio signals with a 360-degree microphone and isolates the target speaker's voice by analyzing unique vocal characteristics, such as pitch, tone, and cadence. A processing unit employs a machine learning model to predict subsequent words or phrases using linguistic context and pre-trained datasets. A targeted counteracting audio signal, 180 degrees out of phase with the speech, is dynamically adjusted for vocal fluctuations and frequency-shifted into the inaudible range to disrupt capture by listening devices. The system synchronizes the signal with the speaker's cadence and adapts to environmental changes in real time. A feedback mechanism refines the signal's effectiveness, while local memory stores user profiles for rapid deployment. Operating entirely on-device, the invention safeguards privacy, ensuring sensitive communications remain protected in diverse settings.

### TECHNICAL FIELD

The inventions disclosed herein pertain to an audio cone of silence for local voice protection in the field of Electrical Audio Signal Processing Systems and Devices. Specifically, the disclosed inventions involve generating, modifying, and transmitting audio signals to prevent unauthorized capture by smart listening devices. The disclosed inventions utilize advanced signal manipulation techniques, such as Fast Fourier Transform (FFT), frequency shifting, and phase inversion, to create an audio environment that disrupts the ability of devices to interpret or record speech.

### DESCRIPTION OF THE RELATED ART

In modern environments, the proliferation of voice-enabled devices such as virtual assistants, smartphones, and home automation systems has introduced significant privacy concerns. These devices are designed to listen for voice commands, often using always-on microphones to detect activation phrases. However, this feature creates vulnerabilities, as such devices may inadvertently or deliberately capture sensitive conversations. The risk of unauthorized listening extends beyond personal privacy to corporate and governmental settings, where privileged or classified discussions must remain confidential. As these devices become increasingly integrated into everyday life, the challenge of safeguarding verbal communications from unwanted capture has grown substantially.

One of the core problems arises from the fact that voice-enabled devices are not always transparent about when they are recording or transmitting data. Many such devices rely on sophisticated algorithms to continuously process ambient audio in search of keywords or wake words. This processing is not limited to commands but may inadvertently include background conversations, which can be stored, analyzed, or transmitted to external servers without the user's explicit consent. These risks are compounded by the fact that users often lack the technical knowledge or tools to disable or monitor these listening capabilities effectively.

The issue becomes even more pronounced in professional and regulated industries, where compliance with privacy laws and confidentiality standards is paramount. Sensitive discussions in industries such as finance and government can result in severe consequences if leaked or misused. Unauthorized audio capture can lead to breaches of customer trust, regulatory violations, and financial consequences. The inability to ensure a secure auditory environment undermines both operational integrity and the confidence of stakeholders who expect robust privacy measures.

Compounding this problem is the rapid expansion of voice recognition technologies embedded in an ever-growing range of devices. Televisions, remote controls, wearable devices, wireless speakers, and even household appliances are now equipped with voice interfaces. This pervasive integration increases the number of potential listening points, creating a web of vulnerabilities.

Traditional approaches to addressing these risks often rely on disabling or muting individual devices manually. However, these methods are inherently limited and require constant vigilance. For example, users may need to physically interact with each device to ensure it is not listening, an impractical task in environments with multiple devices or where devices are owned by third parties. Moreover, even when muted, some devices have been found to retain the capability to capture audio, either through software vulnerabilities or intentional design.

Another challenge is that even if users attempt to implement physical barriers, such as placing devices in soundproof enclosures, these solutions are inconvenient and often ineffective. Such barriers can degrade device functionality or require specific conditions that are not feasible in dynamic, real-world settings. Furthermore, physical enclosures cannot address devices embedded in objects that users may not recognize as listening-enabled, such as remote controls or light fixtures.

From a technological standpoint, the problem is magnified by the fact that most voice-enabled devices are designed to enhance their recognition capabilities over time. These devices often use cloud-based algorithms that aggregate and analyze data from millions of users to improve accuracy. While this feature benefits functionality, it also creates a centralized repository of sensitive audio data, making it an attractive target for malicious actors. Breaches of these repositories can expose vast amounts of private information, further emphasizing the inadequacy of current safeguards.

The issue is further exacerbated by the lack of user-friendly tools for managing privacy in auditory environments. Existing solutions are often complex, requiring technical expertise to implement or maintain. For example, disabling voice recognition features may involve navigating obscure settings menus or using third-party software that may itself introduce security risks. These barriers make it difficult for average users to take proactive measures to protect their privacy.

The long-standing nature of these issues underscores the significant and unmet need for a solution that ensures the privacy of spoken communications in environments where voice-enabled devices are present.

### SUMMARY OF THE INVENTION

In one aspect, a small application can be installed inline with a handset or headset to enable audio capture using the applicable device's audio frameworks, which may include standard APIs or proprietary frameworks for managing microphone input and speaker output. This application can be designed to perform real-time audio processing and signal manipulation while the device is actively capturing audio. The system can leverage three parallel tasks that operate simultaneously on the captured audio to ensure effective analysis and countermeasure generation.

The first task involves analyzing the captured audio to detect spoken words. This task can use existing speech recognition techniques that rely on natural language processing models, phoneme detection, and word segmentation algorithms. By identifying words in real time, this task provides critical predictive insights into the likely progression of speech. This predictive capability is used to anticipate the target speaker's next words or phrases, enabling the system to preemptively generate audio countermeasures.

The second task can focus on analyzing the timing of the detected words. This can involve measuring the cadence and rhythm of the speech, including pauses, word spacing, and transitions between phrases. The timing data is used to synchronize the playback of counteracting audio signals, ensuring that they are emitted at precise moments to align with the natural flow of speech. The cadence information also serves as a fallback mechanism in cases of computational overload, providing a time-sequenced framework for maintaining real-time operations when other processes lag.

The third task uses a Fast Fourier Transform (FFT) to convert the captured audio from the time domain to the frequency domain. This transformation enables detailed spectral analysis, revealing the frequency components of the audio signal. The FFT task identifies patterns and anomalies in the audio, including signals that are inaudible to the human ear but interruptive to listening devices. Inaudible audio content found is flagged for user notification, as these signals may indicate the presence of unauthorized listening devices or advanced capture systems. Additionally, FFT analysis forms the basis for generating counteracting audio signals that are 180 degrees out of phase with the captured speech, ensuring effective neutralization.

In situations where FFT analysis lags due to high computational demands, the system can employ a fallback mechanism that integrates data from the first and second tasks. The predictive data from the word analysis task and the timing data from the cadence analysis task are merged to generate a proxy for the 180-degree out-of-phase audio. This ensures continuity in the counteracting signal, even when FFT processing is delayed, by maintaining alignment with the speaker's cadence and anticipated speech patterns.

The outputs from all three tasks can be merged using a weighted conditional merge technique. This method heavily prioritizes FFT data when available, as it provides the most precise spectral analysis. However, in cases where FFT data is incomplete or unavailable, the system relies more heavily on predictive and cadence data to fill in the gaps. This merging process creates a coherent and dynamic data stream that forms the foundation for generating the counteracting audio waveform.

The merged data is then used to create a frequency-shifted audio waveform. The system shifts the generated audio signal from the normal human speech frequency range, typically between 80 hz and 8 kHz, into the inaudible range. This frequency shift ensures that the counteracting signal is inaudible to humans while remaining detectable and disruptive to unauthorized audio capture devices. The shift into the inaudible range also minimizes interference with the user's auditory experience, allowing normal conversations to proceed without disruption. The frequency shift eliminates acoustic feedback.

The generated audio waveform can be played back through the handset's speaker. The speaker is calibrated to handle inaudible frequencies, ensuring that the emitted signal is effective in neutralizing personal digital assistants while remaining imperceptible to human ears. The playback is synchronized with the speaker's cadence and adjusted dynamically based on real-time feedback from the processing system. This ensures that the counteracting signal is continuously optimized for effectiveness against a wide range of potential threats, including voice-enabled devices, microphones, and advanced capture systems.

By combining predictive modeling, timing analysis, and spectral analysis, the system offers a robust and adaptive solution for preventing unauthorized audio capture. The application operates entirely on-device, ensuring that no captured audio data is transmitted or stored externally. This local processing enhances privacy and security while also reducing latency, allowing the system to respond in real time to changes in the audio environment. The integration of multiple parallel tasks and fallback mechanisms ensures that the system remains effective even under high computational loads or in complex acoustic conditions.

One aspect of the inventions disclosed herein relates to targeted audio neutralization using predictive modeling, which is an advanced system that provides a highly precise method for preventing unauthorized listening by personal digital assistants (e.g., Siri, Alexa, etc.) by neutralizing spoken words in real time. This system focuses on capturing audio from an environment, isolating the speech patterns of a specific target speaker, and generating signals that effectively mask the speech, making it unintelligible to unauthorized personal digital assistants. The process begins with the use of specialized microphones to detect ambient audio, which is then processed through a series of analytical frameworks to identify and isolate the target speaker's voice from other sounds in the environment.

The audio captured by the system is subjected to rigorous speech analysis to extract key characteristics of the target's voice, such as tone, pitch, cadence, and frequency patterns. These characteristics are used to train a machine learning model capable of predicting the speaker's subsequent words or phrases. This predictive capability is a cornerstone of the invention, as it allows the system to anticipate spoken content before it is fully articulated, enabling the generation of counteracting signals in real time. The prediction process is highly sophisticated, utilizing linguistic patterns, contextual clues, and prior speech data to improve accuracy and responsiveness.

The neutralization of the speaker's voice is achieved through the generation of a counteracting audio signal that is 180 degrees out of phase with the detected speech. This phase inversion effectively cancels the audio signal at the point of detection, ensuring that any unauthorized devices attempting to record or process the voice capture only meaningless data. The invention employs advanced signal processing techniques, including Fast Fourier Transform, to analyze the frequency components of the captured audio and generate the precise counteracting signals needed for neutralization. By isolating the frequency range associated with the target speaker's voice, the system ensures that the neutralization does not interfere with other sounds or voices in the environment.

An innovative aspect of the invention is its use of frequency shifting to move the counteracting signal into the inaudible range, which is typically. This range is inaudible to humans but remains detectable by electronic personal digital assistants. By operating in this frequency range, the invention ensures that the counteracting signals do not disrupt the normal auditory experience of individuals in the environment while still rendering the speaker's voice unintelligible to unauthorized devices. This approach also reduces the risk of interference with other legitimate audio activities, such as conversations or audio playback.

The system is designed to selectively target a specific speaker's voice, even in environments with multiple simultaneous conversations. This selectivity is achieved through the use of voice recognition algorithms that can differentiate between individual speakers based on their unique vocal signatures. These algorithms analyze multiple factors, including pitch variations, speech patterns, and timing, to isolate the target's voice with high precision. This targeted approach is particularly beneficial in situations where privacy is critical for one speaker but not necessary for others, allowing normal interactions to continue unaffected.

The invention is equipped with real-time signal generation capabilities that synchronize the counteracting audio with the target speaker's natural rhythm of speech. By continuously monitoring the timing and cadence of the speaker's voice, the system ensures that the generated signals are perfectly aligned with the spoken words, eliminating any delays or gaps in neutralization. This synchronization is crucial for maintaining consistent and effective masking throughout the conversation, regardless of variations in speech speed or inflection.

Another key feature of the invention is its ability to adapt dynamically to changes in the target speaker's voice or the surrounding audio environment. For example, if the speaker changes their tone, volume, or speech rate, the system recalibrates its signal generation in real time to maintain optimal neutralization. Similarly, if new background sounds or voices are introduced into the environment, the system adjusts its processing to ensure that the target speaker's voice remains isolated and effectively masked.

The system hardware includes microphones, audio emitters, and processing units, each playing a critical role in the operation of the invention. The microphones capture ambient audio with high fidelity, while the processing units analyze the captured data and generate the neutralizing signals. The audio emitters then broadcast these signals into the environment, ensuring comprehensive coverage and protection. The hardware is designed to be compact and portable, allowing the system to be deployed in various settings, from personal spaces to corporate offices.

A unique aspect of the invention is its ability to integrate seamlessly with existing audio devices and frameworks. For instance, the system can be used in conjunction with smartphones, conferencing systems, or other communication devices, leveraging their built-in audio capabilities for signal capture and emission. This compatibility enhances the versatility of the invention and simplifies its deployment in diverse environments.

The invention also includes a calibration process to optimize its performance for individual users. During this process, the system records the target speaker's voice under different conditions and trains its predictive models to recognize and respond to their unique speech patterns. This personalized calibration ensures that the neutralization signals are tailored to the specific user, maximizing the system's effectiveness and reliability.

The predictive modeling component of the invention extends its functionality by incorporating contextual analysis. By understanding the conversational context, the system improves its ability to predict the target speaker's likely words or phrases. This contextual awareness allows the system to adapt its neutralization strategy dynamically, ensuring effective performance even in complex or technical discussions that involve domain-specific language or terminology.

To address potential concerns about computational efficiency, the invention employs lightweight algorithms and pre-trained models optimized for real-time operation. These optimizations minimize processing latency, enabling the system to neutralize speech with minimal delay. The computational efficiency also allows the system to operate effectively on low-power devices, broadening its range of applications.

The invention prioritizes privacy and security by processing all captured audio data locally, without transmitting it to external servers. This local processing not only enhances the speed and reliability of the system but also ensures that sensitive data remains secure and protected from breaches or unauthorized access. The emphasis on local data handling aligns with modern privacy standards and addresses user concerns about data security.

User control and customization are integral to the design of the invention. Users can configure the system to define the range of operation, specify which voices to target, and adjust the intensity of the neutralization signals. These customization options allow users to tailor the system to their specific privacy needs and preferences, providing a flexible and user-friendly solution.

The invention represents a groundbreaking advancement in the field of audio signal processing and privacy protection. By combining advanced predictive modeling, precise signal processing, and real-time operation, it offers a robust and effective solution for safeguarding verbal communication. Its ability to target specific voices, adapt dynamically to changing conditions, and integrate with existing devices underscores its practical utility and innovation. The invention provides a critical tool for ensuring privacy in modern audio environments where unauthorized listening poses a significant risk.

Another aspect of the inventions disclosed herein relates to broad-spectrum audio masking using inaudible data injection, which is an advanced and comprehensive system designed to ensure privacy by disrupting the ability of unauthorized listening devices to capture intelligible audio. The system generates and emits randomized, nonsensical phoneme-like audio data that saturates the environment, effectively rendering all audible speech and sound unrecognizable to devices attempting to record or process audio. The signals emitted by the invention are designed to interfere with voice recognition algorithms, creating an auditory environment hostile to unauthorized listening technologies while remaining imperceptible (i.e., inaudible) to human hearing.

The randomization process is a core feature of this invention. Using a sophisticated randomizer, the system generates unpredictable sequences of phoneme-like data that mimic human speech in structure but lack any coherent linguistic meaning. These randomized signals are designed to overwhelm the processing capabilities of voice-enabled devices, such as virtual assistants, smart speakers, and smartphones. By introducing a continuous stream of nonsensical sounds that vary in tone, pitch, and cadence, the system effectively prevents devices from isolating or identifying legitimate speech, thereby nullifying their audio capture capabilities.

The generated masking signals are transmitted in the inaudible frequency range. This range is chosen because it is outside the auditory perception of humans but well within the operational capabilities of most audio-capturing devices. By operating in this frequency range, the invention ensures that its disruptive signals do not interfere with the user's normal auditory experience or the functionality of authorized audio equipment. This design allows the system to provide robust privacy protection while maintaining an unobtrusive presence in the environment.

The invention's adaptability to the audio characteristics of its surroundings is another significant advancement. The system continuously monitors the environment and dynamically adjusts the intensity, frequency, and complexity of its masking signals based on the detected noise levels and audio patterns. For example, in a quiet room, the system may emit signals at a lower intensity to conserve energy, whereas in a noisy environment, it may increase the signal strength to ensure effective masking. This adaptability allows the invention to operate efficiently in diverse settings without requiring manual intervention or recalibration.

The system's hardware includes several key components that work together to achieve its objectives. The audio emitter, designed specifically for this transmission need, broadcasts the inaudible masking signals across the environment. The randomizer generates the complex phoneme-like data used for masking, ensuring that the signals are both unpredictable and effective. A control unit manages the overall operation of the system, including real-time adjustments to signal parameters and continuous monitoring of the environment to detect changes in audio conditions. These components are designed to work seamlessly, providing consistent and reliable performance.

To prevent conflicts with other devices operating in the inaudible range, the invention incorporates a detection mechanism that identifies existing inaudible energy in the environment. This feature ensures that the system's masking signals do not interfere with legitimate uses of the inaudible spectrum, such as in industrial applications. By analyzing the frequency range for existing signals, the system can modify its output to avoid overlapping frequencies, maintaining compliance with regulatory standards and ensuring compatibility with other technologies.

The invention is designed for portability and ease of use, making it suitable for deployment in a wide range of scenarios. Its compact design allows it to be integrated into existing audio systems or used as a standalone device. Users can carry the system with them and activate it as needed, providing on-demand privacy protection in any environment. This portability is particularly beneficial for individuals who frequently move between different settings, such as corporate offices, public spaces, and personal residences.

Energy efficiency is another consideration in the design of this invention. The system is optimized to minimize power consumption, allowing it to operate for extended periods on battery power or through low-power connections. This energy efficiency ensures that the invention can be used continuously in environments where access to power sources may be limited, such as outdoor settings or temporary installations.

User control and customization are integral to the functionality of the invention. Users can configure the system to define the range of operation, adjust the intensity of the masking signals, and select specific frequency bands to target. These customization options enable users to tailor the system's performance to their specific privacy needs and environmental conditions.

The system's ability to operate without requiring prior knowledge of the audio environment is a significant advantage. Upon activation, the invention begins emitting masking signals immediately, with no need for manual setup or calibration. Its self-adjusting capabilities ensure consistent performance regardless of variations in the environment, making it highly reliable and effective in diverse scenarios. This feature is particularly important for users who may lack the technical expertise or time to configure complex systems.

The invention's masking capability is highly effective against modern voice recognition algorithms that rely on advanced machine learning techniques to process audio. By introducing randomized, nonsensical data into the audio environment, the system confounds these algorithms, preventing them from distinguishing meaningful speech from background noise. This disruption significantly reduces the accuracy of voice-enabled devices, rendering their audio capture capabilities unreliable and effectively neutralizing their functionality.

Security and privacy are fundamental to the design of this invention. All masking signals are generated locally within the device, ensuring that no sensitive audio data is transmitted or stored externally. This local operation eliminates the risks associated with data transmission, such as interception or unauthorized access, and aligns with modern privacy standards. By keeping all operations confined to the device, the invention provides a secure and trustworthy solution for audio privacy.

The invention's broad-spectrum approach makes it particularly well-suited for high-risk environments where privacy concerns are paramount. For example, in corporate settings, the system can protect sensitive discussions from being overheard or recorded by electronic personal digital assistants. Similarly, in personal settings, the invention provides peace of mind by neutralizing electronic personal digital assistants. Its versatility and effectiveness make it an essential tool for maintaining privacy in an increasingly interconnected world.

The broad-spectrum audio masking system represents a groundbreaking advancement in the field of privacy protection. By leveraging the principles of randomization and inaudible data injection, it offers a robust solution to the challenges posed by modern voice-enabled technologies. Its ability to operate seamlessly in diverse environments, adapt dynamically to changing conditions, and integrate user-friendly controls underscores its innovation and practicality. This invention provides a reliable means of ensuring privacy from electronic personal digital assistants, addressing a critical need in contemporary audio environments where unauthorized listening by electronic personal digital assistants poses a growing threat.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for neutralizing a target speaker's voice to prevent unauthorized audio capture by a device involves capturing audio signals from the environment using a microphone configured to detect ambient audio within a predefined range. The microphone ensures high-fidelity sound capture to support accurate analysis of the audio signals. The captured audio signals are analyzed using a processing unit that isolates speech patterns associated with the target speaker. This isolation is based on unique vocal characteristics, including pitch, tone, cadence, and frequency patterns, which differentiate the target speaker's voice from other audio sources within the environment.

The method employs a machine learning model implemented within the processing unit to predict subsequent words or phrases likely to be spoken by the target speaker. This prediction relies on the analyzed speech patterns and contextual data, leveraging natural language processing techniques to anticipate the flow of conversation. Using these predictions, the processing unit generates a counteracting audio signal through an audio signal generator. This counteracting signal is designed to be 180 degrees out of phase with the target speaker's speech, effectively canceling the intelligibility of the voice at the point of detection by unauthorized audio capture devices.

To ensure that the counteracting audio signal remains undetectable by humans while still disruptive to unauthorized devices, the processing unit frequency-shifts the signal into an inaudible range. This frequency shift ensures that the signal does not interfere with human auditory experiences while remaining within the operational detection capabilities of audio capture devices. The frequency shift avoids acoustic feedback. The processing unit also synchronizes the timing of the counteracting audio signal with the target speaker's speech cadence. This synchronization uses predictive timing adjustment algorithms to align the signal precisely with the speaker's anticipated speech segments, enabling real-time neutralization without perceptible delays.

The counteracting audio signal is then broadcast into the environment using an audio emitter operably connected to the audio signal generator. The emitter ensures that the signal is distributed effectively to render the target speaker's voice unintelligible to unauthorized devices. The processing unit dynamically adapts the counteracting audio signal in response to changes in the target speaker's voice characteristics or environmental audio conditions, including variations in tone, volume, and background noise. This adaptability ensures consistent performance and effective voice neutralization under changing circumstances.

The method also incorporates local memory accessible to the processing unit for storing data representing the target speaker's vocal characteristics. This stored data enables faster identification and neutralization of the target speaker's voice in future interactions, reducing the need for repeated analysis and improving the system's efficiency over time. By integrating advanced signal processing, predictive modeling, and adaptive capabilities, this method provides robust and reliable protection against unauthorized audio capture while preserving user privacy and maintaining real-time responsiveness.

In some arrangements, the microphone is configured with multiple directional sensors, enabling 360-degree audio coverage to capture the target speaker's voice regardless of their position relative to the microphone or the presence of physical barriers. This directional sensitivity ensures accurate detection and enhances the system's ability to isolate relevant audio for processing.

In some arrangements, the processing unit employs a Fast Fourier Transform (FFT) to analyze the frequency components of the captured audio signals. Using frequency-domain filtering techniques, the processing unit isolates the target speaker's voice from overlapping background noise, echoes, and ambient sounds, enabling precise signal generation.

In some arrangements, the machine learning model used by the processing unit is pre-trained on datasets comprising varied linguistic patterns, regional accents, and common speech anomalies. This enables the system to predict subsequent words or phrases spoken by the target speaker under diverse conversational contexts, improving the accuracy of counteracting signal generation.

In some arrangements, the machine learning model further incorporates contextual analysis by identifying semantic and syntactic relationships within the captured speech. The model leverages a natural language processing (NLP) framework to refine its predictions, ensuring precise alignment of counteracting signals with the anticipated speech patterns of the target speaker.

In some arrangements, the processing unit applies an adaptive phase-inversion algorithm to generate counteracting audio signals. This algorithm dynamically adjusts to fluctuations in the target speaker's pitch, amplitude, and inflection, ensuring effective cancellation of intelligible speech even during dynamic conversations.

In some arrangements, the counteracting audio signal spans multiple overlapping frequency bands to neutralize distinct components of the target speaker's vocal range, including fundamental frequencies and harmonics. This multi-band approach enhances the robustness of the neutralization process against unauthorized audio capture devices.

In some arrangements, the synchronization of the counteracting audio signal is achieved by continuously monitoring the target speaker's speech cadence and applying a predictive timing adjustment algorithm. This synchronization ensures that the counteracting signal is emitted in real time and aligns precisely with the target speaker's speech.

In some arrangements, the audio emitter is configured to emit the counteracting audio signal with directional precision. The emitter can use beamforming technology to target specific zones in the environment while minimizing unintended interference with authorized audio devices or nearby conversations.

In some arrangements, the processing unit incorporates a real-time feedback mechanism that continuously analyzes the effectiveness of the counteracting audio signal. The feedback mechanism detects residual intelligibility of the target speaker's voice and iteratively adjusts the signal's amplitude, frequency, and phase to optimize the neutralization process.

In some arrangements, the system stores multiple profiles of individual speakers in local memory. Each profile includes a unique set of vocal characteristics, enabling the system to neutralize the voices of multiple target speakers simultaneously by generating and emitting individualized counteracting signals.

In some arrangements, the processing unit integrates an advanced environmental noise filter that identifies and excludes non-speech audio, such as mechanical sounds and background music, from the analysis and neutralization process. This filtering improves the precision and efficiency of the system by focusing its resources on speech-specific audio.

In some arrangements, the machine learning model used by the system periodically recalibrates based on updated voice data collected from the target speaker. The recalibration accounts for long-term changes in the target speaker's voice, contextual shifts, and environmental conditions, ensuring the system maintains its predictive accuracy and adaptability over extended use.

In some arrangements, the processing unit combines the use of a randomizer and an audio signal generator to create hybrid masking signals. The randomizer produces phoneme-like data that mimics human speech without coherence, which is then integrated with counteracting audio signals to disrupt both specific target speaker audio and broad-spectrum environmental audio.

In some arrangements, a method for neutralizing a target speaker's voice to prevent unauthorized audio capture by a device and for disrupting audio capture broadly within an environment involves capturing audio signals using a microphone configured to detect ambient audio within a 360-degree range. This microphone employs multiple directional sensors to detect the target speaker's voice, ensuring accurate capture regardless of their position relative to the microphone or the presence of physical barriers. The captured audio signals are analyzed using a processing unit that employs Fast Fourier Transform (FFT) to isolate the frequency components of the target speaker's voice from overlapping background noise, echoes, and ambient sounds by utilizing advanced frequency-domain filtering techniques. The processing unit identifies unique vocal characteristics of the target speaker, including pitch, tone, cadence, and frequency patterns, enabling it to isolate and track the speaker's voice even in the presence of other audio sources.

The method further involves predicting subsequent words or phrases likely to be spoken by the target speaker using a machine learning model implemented within the processing unit. This predictive modeling is based on analyzed speech patterns, contextual relationships identified through a natural language processing framework, and pre-trained datasets comprising diverse linguistic patterns, regional accents, and common speech anomalies. Using the insights from this analysis, the system generates a counteracting audio signal with an audio signal generator operably connected to the processing unit. This counteracting signal is designed to be 180 degrees out of phase with the target speaker's speech, effectively neutralizing the voice at the point of detection by unauthorized audio capture devices. The signal is dynamically adjusted to account for fluctuations in pitch, amplitude, and inflection in the target speaker's vocal characteristics and is configured to cover multiple overlapping frequency bands to neutralize distinct components of the target speaker's vocal range, including fundamental frequencies and harmonics.

The method incorporates frequency-shifting the counteracting signal into an inaudible range using the processing unit, ensuring the signal remains inaudible to humans while remaining disruptive to unauthorized audio capture devices. The system also uses a randomizer operably connected to the processing unit to generate phoneme-like data or nonsensical audio signals that mimic human speech in tone, pitch, and cadence but lack coherent linguistic meaning. These signals are dynamically varied to ensure unpredictability, effectively disrupting voice recognition systems. A broad-spectrum audio masking module integrated into the processing unit combines the counteracting signal with the phoneme-like data generated by the randomizer, creating a comprehensive masking signal that neutralizes both targeted and broad-spectrum audio within the environment.

To ensure precision, the processing unit synchronizes the timing of the combined masking signal with the target speaker's speech cadence using a predictive timing adjustment algorithm. This pre-aligns the signal's emission with anticipated speech segments, enabling real-time neutralization without perceptible delay. The combined masking signal is then broadcast into the environment using an audio emitter operably connected to the audio signal generator. The emitter uses beamforming technology to target specific zones with directional precision while also ensuring wide-area coverage to comprehensively disrupt unauthorized audio capture devices across the system's operational range.

The system dynamically adapts the combined masking signal in response to changes in the target speaker's vocal characteristics, ambient noise levels, and the presence of unauthorized audio capture devices. Adjustments account for variations in tone, volume, and background noise. An inaudible energy detection mechanism integrated into the processing unit detects existing inaudible signals within the environment and modifies the combined masking signal to avoid interference with legitimate uses of the inaudible frequency spectrum, ensuring compliance and minimal disruption to authorized applications.

The method includes storing multiple profiles of individual speakers in local memory, each profile containing a unique set of vocal characteristics. This feature enables the system to neutralize the voices of multiple target speakers simultaneously by generating and emitting individualized counteracting audio signals for each profile. To enhance precision, the processing unit incorporates an advanced environmental noise filter that identifies and excludes non-speech audio, such as mechanical sounds and background music, from the analysis and neutralization processes.

The system periodically recalibrates the machine learning model using updated voice data from the target speaker, accounting for long-term voice changes, contextual shifts, and evolving environmental conditions. This recalibration ensures improved predictive accuracy and adaptability over extended use. Finally, the system ensures that all signal generation, analysis, and neutralization processes occur locally on the device, preventing the external transmission or storage of sensitive audio data and safeguarding user privacy and data security.

In some arrangements, a system for neutralizing a target speaker's voice to prevent unauthorized audio capture by a device includes a microphone configured to capture audio signals from an environment within a 360-degree range. The microphone employs multiple directional sensors to detect the target speaker's voice regardless of their position relative to the microphone or the presence of physical barriers, ensuring comprehensive and precise audio capture. The system includes a processing unit operably connected to the microphone, which is configured to analyze the captured audio signals using a Fast Fourier Transform (FFT). This analysis isolates the frequency components of the target speaker's voice from overlapping background noise, echoes, and ambient sounds using advanced frequency-domain filtering techniques. The processing unit identifies unique vocal characteristics of the target speaker, such as pitch, tone, cadence, and frequency patterns, allowing it to isolate and track the speaker's speech even in the presence of competing audio sources.

The processing unit further utilizes a machine learning model to predict subsequent words or phrases likely to be spoken by the target speaker. This prediction is based on analyzed speech patterns, contextual relationships identified through a natural language processing framework, and pre-trained datasets comprising varied linguistic patterns, regional accents, and common speech anomalies. Additionally, the processing unit dynamically adapts the system's response to changes in the target speaker's voice characteristics or environmental audio conditions, including variations in tone, volume, and background noise. This adaptability ensures that the system maintains effective performance under diverse and evolving conditions.

The system incorporates an audio signal generator operably connected to the processing unit, which generates a counteracting audio signal designed to neutralize the target speaker's voice at the point of detection by unauthorized audio capture devices. This counteracting signal is 180 degrees out of phase with the target speaker's speech, dynamically adjusted to account for fluctuations in pitch, amplitude, and inflection, and configured to cover multiple overlapping frequency bands. By addressing fundamental frequencies and harmonics within the target speaker's vocal range, the system ensures comprehensive neutralization.

To enhance its effectiveness, the system includes a frequency-shifting module integrated into the processing unit. This module shifts the counteracting audio signal into an inaudible range, ensuring that the signal is inaudible to humans while remaining detectable and disruptive to unauthorized audio capture devices. The audio emitter, operably connected to the audio signal generator, broadcasts the counteracting audio signal into the environment. Using beamforming technology, the emitter provides directional precision to target specific zones while minimizing interference with authorized audio devices or nearby conversations.

The system also integrates a feedback mechanism within the processing unit, continuously analyzing the effectiveness of the counteracting audio signal by detecting residual intelligibility of the target speaker's voice in the captured audio. The feedback mechanism iteratively adjusts the signal's amplitude, frequency, and phase to optimize neutralization, ensuring consistent performance in real-time scenarios. A local memory module connected to the processing unit stores multiple profiles of individual speakers, each comprising a unique set of vocal characteristics. This enables the system to neutralize the voices of multiple target speakers simultaneously by generating and emitting individualized counteracting audio signals for each profile.

To enhance precision, the system includes an environmental noise filter integrated into the processing unit. This filter identifies and excludes non-speech audio, such as mechanical sounds and background music, from the analysis and neutralization processes, thereby improving overall system performance. The calibration module periodically recalibrates the machine learning model based on updated voice data collected from the target speaker, accounting for long-term voice changes, contextual shifts, and environmental conditions to maintain predictive accuracy and adaptability over extended periods.

Finally, a security module integrated into the system ensures that all signal generation, analysis, and neutralization processes occur locally on the device. This design prevents the external transmission or storage of sensitive audio data, safeguarding user privacy and data security. By integrating these components and functionalities, the system provides a robust and adaptable solution for preventing unauthorized audio capture while ensuring privacy in a wide range of environments.

In some arrangements, the system for neutralizing a target speaker's voice to prevent unauthorized audio capture incorporates a microphone with a noise-canceling array. This noise-canceling array is configured to enhance the clarity of the target speaker's voice by suppressing ambient noise, echoes, and overlapping conversations before the captured signals are processed by the processing unit. By improving the quality of the input audio, the system ensures that subsequent signal processing and analysis are more precise and effective in isolating and neutralizing the target speaker's voice.

In some arrangements, the machine learning model within the processing unit is configured to perform real-time contextual analysis using a preloaded linguistic database. This capability enables the prediction of industry-specific or domain-specific terminology in conversations involving the target speaker. By leveraging this specialized database, the system enhances its ability to anticipate speech patterns in technical or specialized discussions, ensuring that the counteracting signals are highly accurate and responsive to the target speaker's vocabulary and linguistic context.

In some arrangements, the audio emitter is further configured to dynamically adjust its beamforming parameters to target specific areas within the environment. This feature allows the system to focus its masking signals on zones near known or suspected audio capture devices while minimizing interference with other areas. By optimizing the emitter's focus, the system ensures precise disruption of unauthorized audio capture without unnecessarily impacting authorized audio functions or conversations occurring elsewhere in the environment.

In some arrangements, the system includes a randomizer operably connected to the processing unit, configured to generate phoneme-like data or nonsensical audio signals. These signals mimic human speech in tone, pitch, and cadence but lack coherent linguistic meaning. The randomizer dynamically varies these signals to ensure unpredictability, effectively disrupting the functionality of voice recognition systems. A broad-spectrum audio masking module integrated into the processing unit combines the counteracting audio signals generated by the audio signal generator with the phoneme-like data from the randomizer to create a comprehensive masking signal. This combined signal is broadcast across a wide range of frequencies, including both audible and inaudible ranges, neutralizing all intelligible audio within the environment regardless of its source. The masking module dynamically adapts the intensity, frequency, and complexity of the masking signal in response to changes in ambient noise levels and the presence of unauthorized audio capture devices, ensuring continuous effectiveness in dynamic conditions.

In some arrangements, the system includes an inaudible energy detection mechanism integrated into the processing unit. This mechanism identifies existing inaudible signals in the environment and adjusts the masking signal to avoid conflicts with legitimate uses of the inaudible frequency spectrum, such as in industrial applications. The audio emitter is further configured to broadcast the combined masking signal with both directional precision, using beamforming technology, and wide-area coverage. This dual functionality ensures comprehensive protection against unauthorized audio capture devices across the entire operational range of the system, addressing both targeted and broad-spectrum threats while maintaining the integrity of authorized activities within the environment.

In some arrangements, a method for disrupting unauthorized audio capture in an environment using broad-spectrum audio masking with inaudible data injection begins by capturing audio signals from the environment. This is achieved using a microphone configured to detect ambient audio within a predefined range and relay the captured signals to a processing unit. The processing unit analyzes these signals to detect background noise levels, identify active voice or sound sources, and characterize ambient audio conditions, including the identification of frequencies used by unauthorized audio capture devices. This analysis forms the foundation for generating masking signals tailored to disrupt audio capture effectively.

The method employs a randomizer operably connected to the processing unit to generate phoneme-like data or nonsensical audio signals. These signals mimic human speech in tone, pitch, and cadence but lack coherent linguistic meaning, ensuring that voice recognition algorithms are disrupted. The generated signals are dynamically varied to maximize unpredictability, enhancing their effectiveness against unauthorized devices. The processing unit's broad-spectrum audio masking module combines the phoneme-like data from the randomizer with dynamically adjusted masking audio signals to create a comprehensive masking signal. This masking signal neutralizes intelligible audio capture across a wide frequency range, ensuring robust disruption of unauthorized listening efforts.

The masking signal is frequency-shifted into an inaudible range by the processing unit, ensuring that it remains inaudible to humans while remaining detectable and disruptive to unauthorized audio capture devices. The audio emitter, operably connected to the processing unit, broadcasts this comprehensive masking signal into the environment, saturating both the audible and inaudible frequency ranges to disrupt all intelligible audio within the operational area. To address dynamic conditions, the processing unit adapts the intensity, frequency, and complexity of the masking signal in real-time, responding to changes in ambient noise levels, the introduction of new audio sources, or the detection of unauthorized audio capture devices within the environment.

The system incorporates an inaudible energy detection mechanism integrated into the processing unit to identify existing inaudible signals within the environment. This mechanism adjusts the masking signal's parameters to avoid conflicts with legitimate uses of the inaudible frequency spectrum, such as industrial applications. To enhance targeting efficiency, the processing unit applies a directional beamforming algorithm to the audio emitter. This enables precise targeting of specific zones within the environment, such as areas near known or suspected unauthorized audio capture devices, while maintaining minimal interference with authorized audio devices or ongoing conversations.

The system stores data representing previously encountered environmental audio profiles in a local memory accessible to the processing unit. This storage capability allows the system to preconfigure masking signals for similar future environments, optimizing performance and reducing calibration time. Periodic recalibration of the broad-spectrum audio masking module is performed by the processing unit, accounting for updated environmental conditions, audio source dynamics, and newly detected audio capture devices. This recalibration ensures the system's continued effectiveness against evolving threats.

Finally, the system maintains all signal generation, analysis, and masking processes locally on the device. By ensuring that no captured audio data is transmitted or stored externally, the method safeguards user privacy and ensures data security. This comprehensive approach combines advanced signal processing, real-time adaptability, and robust privacy protections to disrupt unauthorized audio capture across a wide range of environments and scenarios.

In some arrangements, the microphone is configured to capture audio signals with 360-degree coverage using an array of directional sensors. Each sensor is tuned to a specific angular range, enabling precise detection of audio from all directions within the environment, including reflections and reverberations from surfaces. This configuration ensures comprehensive audio capture for accurate analysis and masking.

In some arrangements, the processing unit employs a Fast Fourier Transform (FFT) to analyze the frequency components of the captured audio signals. This analysis isolates patterns indicative of unauthorized audio capture devices by identifying signature noise profiles, wake word activations, or algorithmic responses characteristic of such devices. It simultaneously filters out irrelevant background noise to enhance precision.

In some arrangements, the randomizer generates phoneme-like data by dynamically varying parameters such as tone, pitch, cadence, timing, and amplitude. This approach ensures that the generated signals resemble human speech with high variability, introducing complex and unpredictable patterns that disrupt voice recognition technologies across multiple languages and dialects.

In some arrangements, the broad-spectrum audio masking module incorporates machine learning algorithms to analyze historical masking performance stored in the local memory. The results are used to refine the characteristics of the masking signal, including optimizing phoneme selection, timing synchronization, and signal strength, to counter advanced voice recognition systems more effectively.

In some arrangements, the masking signal generated by the processing unit is configured to span multiple frequency bands, including overlapping audible (20 Hz to 20 kHz) and inaudible ranges. This configuration ensures comprehensive masking of all intelligible audio across devices with varying sensitivity and detection capabilities, including legacy and modern listening devices.

In some arrangements, the processing unit dynamically adjusts the masking signal's intensity, frequency composition, and duration in real time. Adjustments are based on fluctuations in ambient noise levels, the introduction of new audio sources, and the detected operational characteristics of unauthorized audio capture devices, such as microphone sensitivity and frequency range.

In some arrangements, the inaudible energy detection mechanism identifies frequency ranges currently in use by legitimate devices, such as diagnostic equipment or industrial sensors. It modifies the masking signal to avoid interference with those devices while maintaining effective disruption of unauthorized audio capture technologies within the environment.

In some arrangements, the audio emitter applies an advanced beamforming algorithm to focus the masking signal on high-risk zones identified by the processing unit, such as areas near known or suspected unauthorized audio capture devices. The emitter simultaneously maintains wide-area coverage to ensure complete masking of intelligible audio throughout the operational range of the system.

In some arrangements, the feedback mechanism integrated into the processing unit monitors the residual intelligibility of ambient audio by analyzing the effectiveness of the masking signal in disrupting patterns recognizable by voice recognition systems. The system iteratively adjusts the masking signal's parameters, including frequency shifts and amplitude, to enhance disruption and minimize gaps in coverage.

In some arrangements, the processing unit incorporates a filtering algorithm to isolate and exclude non-speech audio, such as mechanical sounds, background music, and irrelevant ambient noise, from the masking process. This optimization improves the masking signal's effectiveness in disrupting speech-focused audio capture technologies while reducing computational overhead.

In some arrangements, the local memory stores profiles of previously detected unauthorized audio capture devices, including their operational characteristics, such as frequency ranges, microphone sensitivity, and signal processing algorithms. The processing unit uses this data to preconfigure masking signals to counter known threats immediately upon detection.

In some arrangements, the processing unit periodically updates the machine learning algorithms using feedback collected from new environments. This refinement enhances the randomizer's phoneme generation and the masking signal's frequency composition, ensuring the system adapts to evolving voice recognition technologies, including systems employing artificial intelligence or adaptive learning.

In some arrangements, the processing unit implements an adaptive calibration process that dynamically adjusts the system's masking capabilities to accommodate high-complexity environments. These environments may include those with multiple overlapping conversations, reflective surfaces, and varied audio profiles, ensuring robust and continuous masking performance under all conditions, including large-scale corporate or public environments.

In some arrangements, a method for preventing unauthorized audio capture in an environment combines targeted audio neutralization using predictive modeling with broad-spectrum audio masking through inaudible data injection. The method involves capturing audio signals from the environment using a microphone configured to detect ambient audio within a 360-degree range. This microphone employs multiple directional sensors to detect speech, background noise, and reverberations, ensuring comprehensive audio input for subsequent processing. A processing unit operably connected to the microphone analyzes the captured audio signals to identify the frequency spectrum, intensity, and unique patterns of audio sources within the environment. This analysis includes isolating specific vocal characteristics of a target speaker and detecting operational characteristics of unauthorized audio capture devices.

The processing unit employs a machine learning model to predict subsequent words or phrases likely to be spoken by the target speaker. This prediction is based on vocal characteristics, linguistic context, and pre-trained datasets comprising diverse speech patterns, regional accents, and contextual relationships. Using this prediction, an audio signal generator operably connected to the processing unit creates a targeted counteracting audio signal. This signal is 180 degrees out of phase with the speech of the target speaker, neutralizing intelligible audio at the point of detection by unauthorized devices. The counteracting audio signal is dynamically adjusted to account for variations in the target speaker's pitch, tone, cadence, and inflection, and it is synchronized with the target speaker's speech cadence using a timing adjustment algorithm to ensure real-time neutralization without latency

Simultaneously, a randomizer operably connected to the processing unit generates phoneme-like data or nonsensical audio signals. These signals mimic human speech in tone, pitch, cadence, and timing but lack coherent linguistic meaning. They are dynamically varied to disrupt voice recognition technologies effectively. The processing unit combines the targeted counteracting audio signal with the phoneme-like data from the randomizer to create a hybrid masking signal that neutralizes the target speaker's speech while also disrupting broad-spectrum environmental audio. The hybrid masking signal is frequency-shifted by the processing unit into an inaudible range, ensuring it is inaudible to humans but detectable by unauthorized audio capture devices.

An audio emitter operably connected to the audio signal generator broadcasts the hybrid masking signal into the environment. The audio emitter provides directional precision to target zones at high risk of unauthorized audio capture, such as areas near known or suspected devices, while also ensuring wide-area coverage to neutralize intelligible audio across the system's operational range. The hybrid masking signal is dynamically adapted by the processing unit in response to real-time changes in ambient noise levels, the introduction of new audio sources, or variations in the target speaker's vocal characteristics, including tone, volume, and cadence.

An inaudible energy detection mechanism integrated into the processing unit detects existing inaudible signals within the environment and modifies the hybrid masking signal to avoid interference with legitimate uses of the inaudible spectrum, such as those for industrial or other devices. A feedback mechanism within the processing unit monitors the effectiveness of the hybrid masking signal by analyzing residual intelligibility in captured audio and iteratively adjusting the signal's frequency, intensity, and phase to optimize disruption.

To enhance the efficiency and focus of the masking process, an environmental noise filter integrated into the processing unit filters out non-speech audio such as mechanical sounds, background music, and irrelevant noise, optimizing the signal for disrupting speech-focused audio capture technologies. Data representing previously encountered audio profiles and detected unauthorized devices are stored in local memory accessible to the processing unit. This stored data enables the system to preconfigure masking signals for similar environments in future scenarios, improving performance and reducing recalibration time.

The processing unit periodically recalibrates the randomizer, machine learning model, and hybrid masking signal based on updated environmental audio conditions, historical masking performance data, and newly detected unauthorized devices. This recalibration ensures the system maintains long-term effectiveness against evolving threats. Finally, the system maintains all signal generation, analysis, masking, and recalibration processes locally on the device, ensuring that no captured audio data is transmitted or stored externally. This local operation safeguards user privacy and ensures data security, providing a robust and comprehensive solution for preventing unauthorized audio capture in a wide range of environments.

In some arrangements, a system for disrupting unauthorized audio capture in an environment uses broad-spectrum audio masking with inaudible data injection to provide comprehensive protection. The system includes a microphone configured to capture audio signals from the environment within a predefined range. This microphone employs an array of directional sensors to detect sound from all directions, including reflections and reverberations, and relays the captured signals to a processing unit. The processing unit is operably connected to the microphone and is designed to analyze the captured audio signals to identify frequency patterns, noise levels, and sound sources within the environment. It further detects operational characteristics of unauthorized audio capture devices, such as microphone sensitivity and active frequency ranges, and generates masking parameters based on the environmental audio profile and detected devices. The processing unit dynamically adjusts masking signal parameters to account for changes in the environment, such as the introduction of new audio sources or variations in ambient noise levels.

The system also incorporates a randomizer operably connected to the processing unit, configured to generate phoneme-like data or nonsensical audio signals that mimic human speech in tone, pitch, cadence, and timing but lack coherent linguistic meaning. The randomizer dynamically varies the generated signals to ensure unpredictability and disrupt voice recognition technologies effectively. An audio signal generator operably connected to the processing unit and the randomizer combines the phoneme-like data with dynamically generated masking signals to produce a comprehensive masking signal. This masking signal spans multiple frequency bands, including audible and inaudible ranges, providing robust disruption of intelligible audio across the environment.

A frequency-shifting module integrated into the processing unit shifts the comprehensive masking signal into an inaudible frequency range. This ensures the masking signal remains inaudible to humans while remaining detectable and disruptive to unauthorized audio capture devices. The system also features an audio emitter operably connected to the audio signal generator. The audio emitter broadcasts the comprehensive masking signal into the environment, providing both directional precision to target specific zones at high risk of unauthorized audio capture and wide-area coverage to ensure comprehensive masking across the operational range. The audio emitter dynamically adjusts its emission parameters based on real-time feedback from the processing unit to optimize masking coverage while minimizing interference with authorized audio devices or ongoing conversations.

An inaudible energy detection mechanism integrated into the processing unit identifies existing inaudible signals within the environment and adjusts the masking signal parameters to avoid interference with legitimate uses of the inaudible spectrum, such as industrial or other applications. A feedback mechanism within the processing unit continuously monitors the residual intelligibility of ambient audio, analyzing the effectiveness of the masking signal in disrupting unauthorized audio capture. This mechanism iteratively modifies the masking signal's parameters, including intensity, frequency, and duration, to ensure consistent disruption and adaptability to environmental changes.

The system also includes an environmental noise filter integrated into the processing unit, which identifies and excludes non-speech audio, such as mechanical sounds, background music, and irrelevant noise, from the analysis and masking processes. This filtering enhances the system's precision and efficiency in disrupting speech-focused audio capture technologies. A local memory module operably connected to the processing unit stores profiles of previously encountered environmental conditions and unauthorized audio capture devices, including their operational characteristics. This stored data allows the system to preconfigure masking signals for similar future scenarios, reducing setup and calibration time.

A calibration module integrated into the processing unit periodically recalibrates the randomizer, audio signal generator, and masking parameters based on updated environmental conditions, newly detected unauthorized devices, and historical performance data. This ensures the system adapts to evolving threats and maintains optimal masking performance over time. Finally, the system includes a security module designed to ensure that all signal generation, analysis, masking, and recalibration processes are performed locally on the device. This prevents the transmission or external storage of captured audio data, thereby safeguarding user privacy and ensuring data security. The system provides a comprehensive, adaptive, and privacy-preserving solution for disrupting unauthorized audio capture in diverse and dynamic environments.

In some arrangements, the system for disrupting unauthorized audio capture employs a processing unit configured with a machine learning algorithm trained on historical audio profiles and device behavior patterns. This training enables the detection and classification of unauthorized audio capture devices based on their unique acoustic and operational characteristics, including wake word activation and frequency response patterns. By leveraging these learned profiles, the processing unit can identify potential threats with high accuracy and adapt the system's masking capabilities accordingly to neutralize the detected devices.

In some arrangements, the randomizer dynamically adjusts the phoneme-like data it generates by incorporating linguistic diversity. This includes variations in phonetic structures derived from multiple languages, ensuring enhanced disruption of voice recognition technologies that operate across multilingual datasets or adaptive learning systems. By introducing phoneme diversity, the system effectively counters advanced recognition algorithms capable of handling diverse linguistic inputs, thereby improving the masking signal's overall effectiveness in preventing unauthorized audio capture.

In some arrangements, the audio emitter utilizes an advanced beamforming algorithm to selectively direct the comprehensive masking signal toward zones of high risk. These zones include areas with multiple detected unauthorized audio capture devices, such as clustered smart speakers or interconnected voice-enabled systems. Simultaneously, the emitter maintains a baseline wide-area coverage to ensure consistent masking throughout the environment, safeguarding against unauthorized devices that may not have been directly identified.

In some arrangements, the processing unit integrates a predictive modeling module configured to analyze the speech patterns of target speakers within the environment. This module identifies unique vocal characteristics, including pitch, tone, and cadence, and predicts subsequent words or phrases using a machine learning model trained on contextual and linguistic datasets. Based on this analysis, the system generates a targeted counteracting audio signal through the audio signal generator. This signal is 180 degrees out of phase with the detected speech of the target speaker, effectively neutralizing intelligible audio at the point of detection by unauthorized audio capture devices.

The system combines the targeted counteracting audio signal with the comprehensive masking signal generated by the randomizer, creating a hybrid masking signal that disrupts both the specific audio of the target speaker and the broader environmental audio. This hybrid masking signal is synchronized with the cadence of the target speaker's speech using a timing adjustment algorithm within the processing unit, ensuring real-time neutralization of detected speech without latency. The hybrid masking signal dynamically adapts based on changes in the target speaker's vocal characteristics, such as variations in pitch, tone, and cadence, as well as changes in environmental audio conditions, including ambient noise levels and the introduction of new audio sources. This adaptability allows the system to provide simultaneous targeted neutralization and broad-spectrum masking, delivering comprehensive disruption of unauthorized audio capture across the entire environment.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts a system component diagram illustrating the core elements and functionalities of the inventions, including the microphone for audio capture, the processing unit for audio analysis and signal processing, the audio signal generator for creating counteracting and masking signals, the frequency-shifting module for inaudible signal conversion, and the audio emitter for broadcasting signals with precision and coverage. Additionally, FIG. 1 shows specific functionalities, such as targeted audio neutralization and broad-spectrum audio masking.

FIG. 2 depicts a sequence diagram illustrating the operational flow of a sample targeted audio neutralization system using predictive modeling, starting with the target speaker's voice capture and proceeding through signal analysis, prediction of subsequent speech, and generation of a counteracting signal. It further demonstrates the steps for frequency-shifting the counteracting signal, broadcasting it to the environment, rendering the target speaker's voice unintelligible to unauthorized devices, and dynamically adapting the signal while storing voice characteristics in local memory.

FIG. 3 depicts a sequence diagram for the operation of a sample broad-spectrum audio masking system using inaudible data injection, showing the flow from capturing environmental audio signals through their analysis, masking signal generation, and disruption of unauthorized audio capture. It further details adaptive signal refinement, environmental profile storage, periodic recalibration, and localized processing to ensure privacy and effectiveness.

FIG. 4 depicts a class diagram for sample targeted audio neutralization using predictive modeling, outlining the relationships and interactions between the key components, including the microphone, processing unit, audio signal generator, audio emitter, local memory, calibration module, and security module. The diagram illustrates the functionality of each component, such as audio capture, signal generation, frequency shifting, feedback analysis, and storage of speaker profiles, highlighting how these components integrate to achieve effective and adaptive audio neutralization.

FIG. 5 depicts a class diagram for sample broad-spectrum audio masking utilizing inaudible data injection, showcasing components such as the processing unit, randomizer, audio signal generator, and frequency-shifting module, which collectively generate and emit disruptive masking signals to neutralize unauthorized audio capture. The diagram highlights functional interactions, including signal analysis, phoneme-like data generation, and adaptive emission of masking signals, ensuring comprehensive environmental audio protection.

FIG. 6 depicts a sample usage flow diagram illustrating the process of audio analysis and masking, starting with audio bleed and progressing through speech recognition, timing and frequency analysis, and generation of inverted-phase audio signals. The figure highlights steps such as detecting infrasound, merging vocal patterns, and dynamically generating and broadcasting masking signals to neutralize unauthorized audio capture.

FIG. 7 depicts a sample environmental deployment of an audio interference device (AID) within a typical smart-enabled setting, showing its interaction with various devices, including corporate phones, personal smart devices, smart TVs, and speakers. The figure highlights the AID's capability to emit masking signals via Bluetooth or wired connections, disrupting audio capture by unauthorized devices within the deployment range. Protected audio can be masked by data injection and/or neutralized by target such that the audio is not decipherable by smart devices within the environment, whereas non-confidential audio can be allowed from other users in the same environment, if desired, to be sent without masking or neutralization to smart devices for normal processing and utilization.

### DETAILED DESCRIPTION

The disclosed inventions represent highly advanced systems and methods designed to address the critical need for privacy in environments where unauthorized audio capture is a significant risk. These inventions operate independently or complementarily, offering targeted and broad-spectrum solutions to safeguard verbal communication. One invention employs targeted audio neutralization using predictive modeling to address the specific voice of an identified speaker, while the second invention provides comprehensive audio masking through broad-spectrum signals incorporating inaudible data injection to disrupt all unauthorized audio capture within an environment. Each invention leverages state-of-the-art technologies to ensure privacy, adaptability, and efficiency, all while maintaining data security by performing all processes locally on the device.

The targeted audio neutralization system captures audio using a 360-degree microphone that employs directional sensors to ensure full environmental coverage. The captured audio is relayed to a processing unit that isolates the target speaker's voice by analyzing unique vocal characteristics such as pitch, tone, cadence, and inflection. A machine learning model implemented within the processing unit is trained on a diverse set of linguistic patterns, regional accents, and speech anomalies, enabling it to predict subsequent words or phrases that the target speaker is likely to say. This predictive capability is a cornerstone of the invention, as it allows the system to prepare a counteracting audio signal in advance of the speaker completing their phrase, ensuring seamless operation in real time.

The counteracting audio signal is tailored to neutralize the target speaker's voice. It is generated 180 degrees out of phase with the detected speech, effectively canceling the sound at the point of detection by unauthorized devices. The system dynamically adjusts the signal to account for fluctuations in the target speaker's vocal characteristics, such as changes in tone, volume, or speech speed. Additionally, the signal is frequency-shifted into the inaudible range, making it inaudible to humans but detectable and disruptive to devices that rely on audio capture and recognition algorithms. By operating in this range, the system maintains a discreet presence while providing robust protection against unauthorized audio capture.

The targeted system incorporates advanced synchronization capabilities. Using a timing adjustment algorithm, the system aligns the emission of the counteracting signal with the natural cadence of the target speaker's speech, ensuring that the neutralization occurs without perceptible latency. This synchronization is essential for maintaining the flow of conversation without disruption, especially in environments where real-time communication is critical. The system further adapts dynamically to changes in the environment, such as fluctuations in ambient noise levels or overlapping conversations, ensuring that the counteracting signal remains effective even under complex conditions.

A feature of the targeted system is its ability to store user profiles in local memory. These profiles include data on the unique vocal characteristics of specific speakers, enabling the system to quickly and accurately identify and neutralize previously encountered voices in future scenarios. This stored data also allows the system to expedite its setup process and maintain consistent performance across repeated deployments. By keeping all operations confined to the device, the system ensures that sensitive audio data is never transmitted or stored externally, preserving user privacy and preventing unauthorized access.

Another invention, broad-spectrum audio masking using inaudible data injection, takes a different but complementary approach to audio capture prevention. This system captures ambient audio using a 360-degree microphone and analyzes it to detect background noise levels, active audio sources, and potential unauthorized audio capture devices. The processing unit identifies operational characteristics of these devices, such as their sensitivity, frequency range, and algorithmic behavior, enabling the system to optimize its masking signal for maximum disruption.

A randomizer within the system generates phoneme-like data that mimics human speech in tone, pitch, and cadence but lacks coherent linguistic meaning. This data is dynamically varied to ensure unpredictability and effectively disrupt voice recognition systems that rely on structured linguistic patterns. The generated phoneme-like data is combined with masking signals that span both audible and inaudible frequency ranges. This comprehensive masking signal neutralizes all intelligible audio within the environment, ensuring that no sound source, whether from a human speaker or a background noise, can be effectively captured by unauthorized devices.

The system frequency-shifts the masking signal into the inaudible range, ensuring that it is inaudible to humans while remaining highly disruptive to listening devices. An advanced audio emitter broadcasts the masking signal throughout the environment, using beamforming technology to target specific high-risk zones while also providing wide-area coverage. This dual functionality allows the system to protect both localized and large-scale environments with equal efficacy.

The broad-spectrum system is designed to adapt dynamically to changing environmental conditions. It continuously monitors the audio environment, adjusting the intensity, frequency, and complexity of the masking signal in response to fluctuations in noise levels, the introduction of new audio sources, or the detection of additional unauthorized devices. A feedback mechanism analyzes the residual intelligibility of captured audio and iteratively refines the masking signal to ensure continuous disruption. This adaptability makes the system effective in diverse scenarios, from quiet personal spaces to noisy public settings.

To prevent interference with legitimate uses of the inaudible spectrum, such as industrial applications, the system can include an inaudible energy detection mechanism. This feature ensures that the masking signal avoids frequency ranges currently in use by authorized devices, allowing the system to operate in shared environments without causing unintended disruptions. The system also incorporates an environmental noise filter to exclude irrelevant sounds, such as mechanical noise or background music, from the analysis and masking processes, optimizing its performance and reducing computational overhead.

Both inventions are designed to maintain effectiveness over time by incorporating machine learning and adaptive algorithms. The targeted system periodically updates its predictive model using feedback from real-world usage, while the broad-spectrum system recalibrates its randomizer and masking signal based on new environmental data. These updates ensure that the inventions remain capable of countering evolving threats, such as advanced voice recognition technologies and adaptive audio capture algorithms.

By operating entirely on-device, both inventions provide unparalleled privacy and data security. All signal generation, analysis, and masking processes are confined to the system, ensuring that no audio data is transmitted or stored externally. This design not only safeguards sensitive communications but also eliminates dependencies on external networks or cloud services, enhancing the systems'reliability and speed.

The inventions address distinct but complementary aspects of audio capture prevention. The targeted system is ideal for scenarios requiring the protection of specific speakers, such as corporate boardrooms or private consultations. In contrast, the broad-spectrum system excels in environments where multiple conversations or ambient sounds need comprehensive masking, such as public spaces or high-security areas. Together, these systems provide a robust and versatile solution for modern audio privacy challenges, ensuring that sensitive communications remain protected in any environment.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

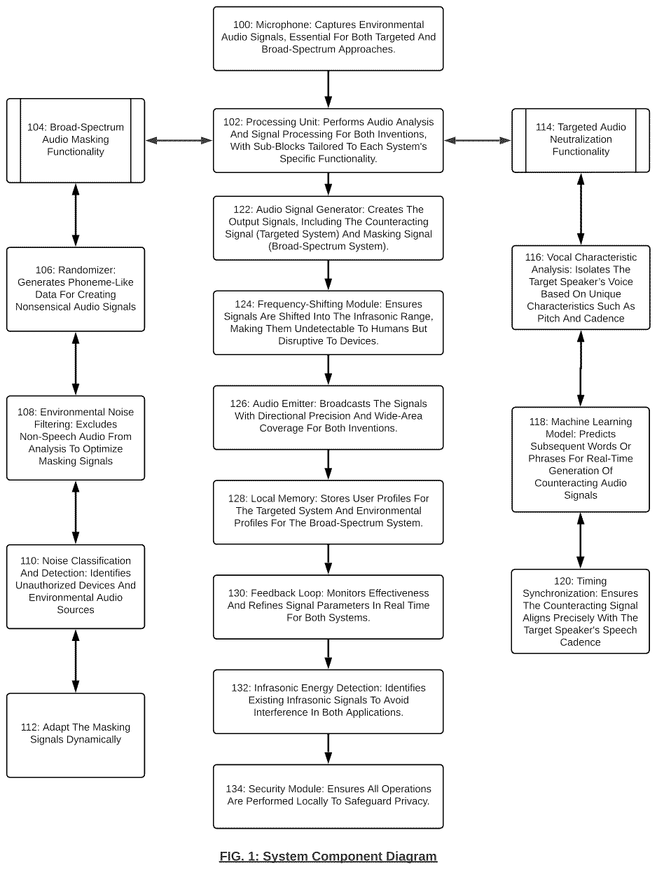

FIG. 1 depicts a comprehensive block diagram that illustrates the system architecture for audio privacy protection, showcasing the integration of both targeted audio neutralization using predictive modeling and broad-spectrum audio masking with inaudible data injection. The system incorporates components designed to address shared functionalities and unique features, enabling robust protection against unauthorized audio capture in diverse environments. The microphone, labeled 100, serves as the entry point for audio data, capturing environmental sounds from all directions using advanced directional sensors. This microphone is capable of detecting speech, background noise, and even subtle reverberations, ensuring a complete representation of the acoustic environment. The captured signals are relayed to the processing unit, labeled 102, which is the core analytical hub responsible for managing the system's advanced functionalities.

The processing unit, labeled 102, is designed to perform parallel tasks that cater to both the targeted and broad-spectrum systems.

Broad-spectrum audio masking functionality 104 can include randomizer 106 that generates phoneme-like data for creating nonsensical audio signals, environmental noise filtering 108 that excludes non-speech audio from analysis to optimize masking signals, noise classification and detection 110 that identifies unauthorized devices and environmental audio sources, and adaptation 112 of the masking signals dynamically.

Targeted audio neutralization functionality 114 includes vocal characteristic analysis 116 that isolates the target speaker's voice based on unique characteristics such as pitch and cadence, one or more machine learning model(s) 118 that predict subsequent words or phrases for real-time generation of counteracting audio signals, and timing synchronization 120 that ensures the counteracting signal aligns precisely with the target speaker's speech cadence.

The vocal characteristic analysis module can isolate the target speaker's voice from overlapping audio sources by identifying distinct vocal features such as pitch, cadence, tone, and inflection. This module ensures precise identification of the target speaker, even in complex or noisy environments. The machine learning model can leverage a pre-trained dataset of linguistic patterns, regional accents, and speech contexts to predict the target speaker's likely next words or phrases. By using predictive modeling, the system anticipates speech patterns, enabling real-time generation of counteracting audio signals that seamlessly neutralize the speaker's voice.

The randomizer, labeled 106, generates phoneme-like data that mimics the structure of human speech, including variations in tone, pitch, and cadence, but lacks coherent linguistic meaning. The randomizer's output is highly dynamic and randomized to disrupt voice recognition algorithms used by unauthorized devices. The random data is then processed alongside the predictive outputs from the targeted system to create a hybrid masking signal that is both specific and comprehensive.

The audio signal generator, labeled 122, integrates the outputs from the vocal characteristic analysis and randomizer to produce tailored signals for each system. For the targeted system, the generator creates a counteracting signal that is 180 degrees out of phase with the detected speech. This phase inversion cancels the target speaker's voice at the point of detection, rendering it unintelligible to unauthorized devices. The generator dynamically adjusts the amplitude, frequency, and phase of this signal based on real-time feedback, ensuring continuous effectiveness. For the broad-spectrum system, the generator combines the randomizer's nonsensical audio data with masking signals that span both the audible and inaudible ranges, creating a comprehensive disruptive effect that neutralizes all audio capture in the environment.

Once the signals are generated, they are processed by the frequency-shifting module, labeled 124, which converts them from the normal human speech frequency range of 90 Hz to 20kHz into the inaudible range. This frequency shift ensures that the signals are inaudible to humans while remaining highly disruptive to unauthorized devices, such as microphones and voice-enabled systems. The frequency-shifting module adapts the signals to counteract devices with varying operational characteristics, further enhancing the system's effectiveness.

The processed signals are transmitted to the audio emitter, labeled 126, which broadcasts them into the environment. The emitter can employ advanced beamforming technology to direct the signals with precision toward high-risk areas, such as zones near suspected unauthorized devices. In addition to directional precision, the emitter provides wide-area coverage, saturating the environment to ensure that all potential threats are neutralized, even those that may be hidden or difficult to detect. The emitter dynamically adjusts its output based on real-time feedback from the system, ensuring optimal coverage and effectiveness.

A feedback loop, labeled 130, can continuously monitor (if desired) the environment to evaluate the effectiveness of the emitted signals. The feedback mechanism analyzes residual intelligibility in the captured audio, iteratively refining parameters such as frequency, phase, and amplitude to ensure optimal disruption. This real-time adjustment capability allows the system to adapt to changing conditions, such as new audio sources or variations in ambient noise levels. Working alongside the feedback loop is the inaudible energy detection module, labeled 104, which identifies existing inaudible signals within the environment. This module ensures that the system avoids interfering with legitimate uses of the inaudible spectrum, such as industrial devices, while maintaining its disruptive effect on unauthorized devices.

The system's adaptability is further enhanced by the environmental noise filter, labeled 118, which removes irrelevant non-speech sounds, such as mechanical noise or background music, from the captured audio. This ensures that the system focuses on speech-specific signals, optimizing the use of processing resources and improving overall performance. Data processed by the system is stored in a local memory module, labeled 110, which retains user profiles and environmental audio profiles. These stored profiles enable rapid deployment in familiar scenarios, allowing the system to pre-configure signals based on prior data and reducing calibration time.

Dynamic masking adaptation, labeled 112, ensures that the system adjusts its operations in real time to accommodate changes in the environment. This includes responding to fluctuations in noise levels, the introduction of new audio sources, or the detection of additional unauthorized devices. The signal processor, labeled 132, merges data from the randomizer, predictive modeling, and FFT analysis using a weighted conditional merge. This prioritizes FFT data for accuracy while leveraging timing and predictive insights to create a unified and effective signal.

The security module, labeled 134, ensures that all processes, including analysis, signal generation, and storage, are performed locally on the device. This eliminates the need for external data transmission, safeguarding user privacy and ensuring that sensitive information remains secure. By integrating components 100 through 134, FIG. 1 demonstrates a sophisticated system that combines the precision of targeted audio neutralization with the comprehensive coverage of broad-spectrum masking. The result is a scalable, adaptive solution capable of addressing modern audio privacy challenges across diverse and high-risk environments.

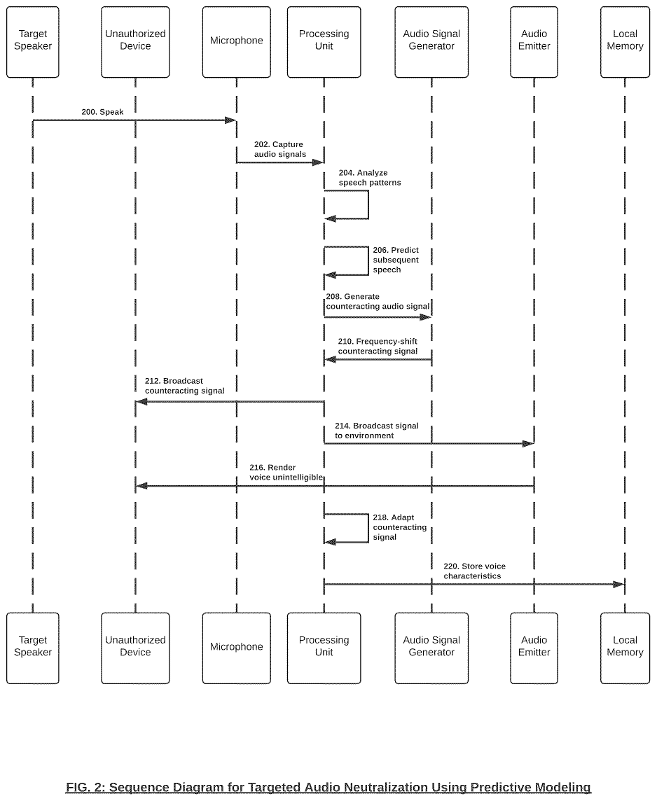

FIG. 2 illustrates a highly detailed sequence diagram of a targeted audio neutralization system utilizing predictive modeling to prevent unauthorized audio capture. The sequence begins at step 200, where the target speaker verbalizes speech within an environment. The microphone, in 202, captures audio signals from all directions, including speech and ambient noise, leveraging its directional sensors for 360-degree coverage. The captured signals are promptly transmitted to the processing unit, which forms the analytical core of the system.

At step 204, the processing unit begins its operations by isolating the target speaker's voice using a vocal characteristic analysis module. This module identifies unique features of the speaker's voice, such as pitch, tone, cadence, and inflection, ensuring precise separation of the target's speech from surrounding environmental sounds or overlapping conversations. This analysis is critical for accurately focusing the system's counteracting mechanisms on the intended target.

Following the isolation of the speaker's voice, at step 206, the processing unit leverages a machine learning model to predict subsequent words or phrases that the target speaker is likely to say. This predictive modeling relies on a pre-trained linguistic dataset that accounts for contextual relationships, speech patterns, and regional accents, enabling the system to anticipate future speech with a high degree of accuracy. The predictive capability ensures that counteracting audio signals are generated in advance, maintaining a seamless and real-time response to the target speaker's verbalizations.

At step 208, the predictive data is utilized by the audio signal generator to create a counteracting signal. This signal is specifically designed to be 180 degrees out of phase with the detected speech of the target speaker. The phase inversion effectively cancels the speaker's voice at the point of detection, rendering it unintelligible to unauthorized audio capture devices. The audio signal generator dynamically adjusts the phase, frequency, and amplitude of the signal in real time to ensure consistent and effective neutralization, even when the target speaker's vocal characteristics change.

The counteracting signal is further processed at step 210 by the frequency-shifting module. This module shifts the signal's frequency into the inaudible range, ensuring that it remains inaudible to human listeners while being disruptive to unauthorized devices, including advanced audio recognition systems. The frequency-shifting module dynamically adapts the signal's parameters to counteract devices with varying operational sensitivities, enhancing the system's effectiveness across diverse threats.

The processed counteracting signal is then transmitted to the audio emitter at step 212. The audio emitter broadcasts the signal with directional precision, targeting specific areas in the environment where unauthorized devices are detected or suspected. In addition to its precise targeting, the emitter ensures wide-area coverage at step 214, saturating the environment to neutralize potential hidden or undetected threats. The signal emitted by the system effectively prevents unauthorized devices from capturing intelligible audio from the target speaker.

At step 216, the broadcasted signal achieves its primary function of neutralizing the target speaker's voice, making it unintelligible to unauthorized audio capture devices. This is achieved through the combined effects of phase inversion, frequency shifting, and dynamic adjustment. The system continuously evaluates the effectiveness of the neutralization process at step 218 using a feedback mechanism integrated within the processing unit. This mechanism monitors the residual intelligibility of the target speaker's voice in the environment and dynamically refines the signal's parameters, including amplitude, phase, and frequency, to ensure optimal performance.

To enhance its operational efficiency, the system incorporates local memory, in 220, which stores unique vocal characteristics of the target speaker. These stored profiles enable the system to quickly recognize and neutralize the same speaker in future interactions, significantly reducing setup time and calibration requirements. The local storage of data ensures that no sensitive information is transmitted externally, maintaining strict privacy and data security for the user.

The system dynamically adapts to changes in the target speaker's vocal characteristics and the environmental audio conditions. For instance, if the target speaker's tone, pace, or volume shifts, the processing unit adjusts the counteracting signal in real time to maintain its effectiveness. This adaptability is crucial in dynamic environments where ambient noise levels or overlapping conversations may vary.

The sequence depicted in FIG. 2 integrates various aspects of the innovations disclosed herein and begins with capturing ambient audio signals and analyzing them for unique vocal characteristics. It leverages machine learning to predict subsequent words or phrases and generates counteracting signals based on real-time predictions. These signals are dynamically adapted to changes in vocal characteristics and shifted into the inaudible range to prevent detection by human listeners while disrupting unauthorized devices. The system emits these signals with directional precision and monitors their effectiveness using a feedback loop, refining signal parameters iteratively. Local memory storage ensures rapid deployment in familiar environments, while dynamic adaptation enables continuous operation in diverse conditions. The system maintains strict data privacy by performing all processes locally.

FIG. 2 exemplifies the seamless integration of predictive modeling, dynamic adaptation, and real-time signal generation to provide robust audio privacy. The system's components work in concert to neutralize the target speaker's voice effectively while adapting to evolving environmental challenges. This innovative architecture ensures that the system addresses the complex and dynamic needs of modern audio privacy protection.

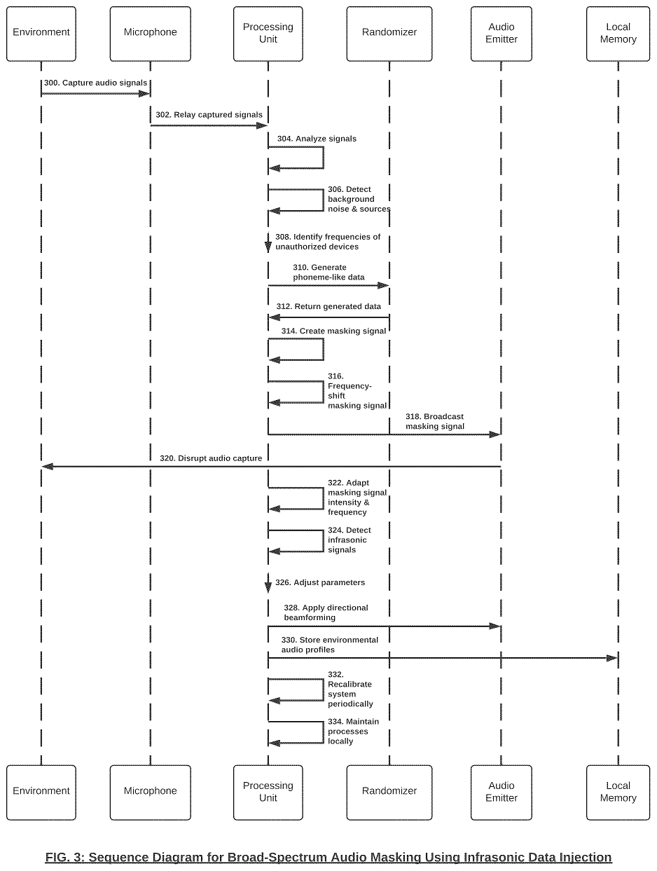

FIG. 3 illustrates a sequence diagram that comprehensively depicts the operational flow of the broad-spectrum audio masking system utilizing inaudible data injection to prevent unauthorized audio capture. This system begins its operation at step 300, where ambient audio signals are generated within the environment. These signals include human speech, background noise, and other environmental sounds that the system must analyze and neutralize to protect privacy.

At step 302, these audio signals are captured by the microphone. The microphone is a 360-degree audio capture device equipped with directional sensors to ensure comprehensive detection of all sound sources, including subtle reverberations and overlapping conversations. It transmits these captured signals to the processing unit, which serves as the analytical and decision-making core of the system.

At step 304, the processing unit begins its multi-faceted analysis of the captured audio signals. It uses advanced algorithms to detect and classify environmental noise levels, identify audio sources, and analyze the operational characteristics of potential unauthorized audio capture devices. A key function at this stage is performed by the environmental noise filter, which removes irrelevant non-speech sounds such as mechanical noise or background music from the captured audio data. This filtering ensures that the system's resources are focused exclusively on analyzing and disrupting critical audio, such as human speech.

At step 306, the processing unit employs the randomizer, to generate phoneme-like data that mimics the cadence, tone, and pitch of human speech but lacks coherent linguistic meaning. This data is dynamically varied to introduce unpredictable patterns into the audio, effectively disrupting voice recognition algorithms used by unauthorized devices. The randomizer's output is critical in forming the foundation of the masking signals, ensuring that they are both comprehensive and effective against a wide range of audio capture technologies.

The randomizer's output, along with data from the environmental noise filter, is processed at step 308 by the audio signal generator. This component creates a hybrid masking signal that spans both audible and inaudible frequency ranges. The signal is designed to neutralize intelligible audio capture by saturating the spectrum that unauthorized devices rely upon for effective operation. The audio signal generator dynamically adjusts the masking signal's intensity, frequency composition, and complexity in response to real-time feedback from the processing unit, ensuring that the signal remains effective under changing environmental conditions.

At step 310, the generated masking signal is transmitted to the frequency-shifting module. This module shifts the signal from the standard audible range to the inaudible spectrum. By operating in this range, the masking signal remains inaudible to humans while being disruptive to unauthorized devices, including advanced voice recognition systems and microphones with extended frequency sensitivity. The frequency-shifting module also ensures that the masking signal avoids interference with legitimate inaudible uses, such as industrial devices, by continuously monitoring the environment for existing inaudible signals.

The processed masking signal is then sent to the audio emitter at step 312. The emitter broadcasts the masking signal into the environment using beamforming technology for precise directional targeting. At step 314, the emitter also ensures wide-area coverage, saturating the entire operational range with the masking signal to neutralize any hidden or undetected unauthorized devices. This dual functionality allows the system to address both localized threats and broader environmental vulnerabilities.

At step 316, the masking signal disrupts all intelligible audio within the environment, rendering it unusable to unauthorized audio capture devices. This is achieved through the combination of phoneme-like data, broad-spectrum masking, and inaudible frequency shifting. The system ensures that the disruption is both thorough and adaptable, maintaining effectiveness even in complex and dynamic environments with overlapping conversations or fluctuating noise levels.

The processing unit continuously monitors the effectiveness of the masking signal at step 318. A feedback mechanism integrated within the processing unit evaluates residual intelligibility in the environment and iteratively refines the masking signal's parameters, such as frequency, phase, and amplitude, to maintain optimal disruption. This feedback loop ensures that the system dynamically adapts to new audio sources, changes in noise levels, and the detection of additional unauthorized devices.

At step 320, the system stores environmental profiles and data about detected devices in the local memory. These stored profiles allow the system to preconfigure masking signals for similar environments in the future, reducing calibration time and improving overall efficiency. The local memory ensures that all data remains on-device, safeguarding user privacy and eliminating the risk of external data breaches.

At step 322, the system undergoes periodic recalibration based on updated environmental conditions and historical feedback from previous operations. This recalibration ensures that the randomizer, audio signal generator, and frequency-shifting module remain effective against evolving threats, including new audio capture technologies and adaptive recognition algorithms. The recalibration process also optimizes the system's performance over time, ensuring long-term reliability and adaptability.

The operational flow depicted in FIG. 3 begins with capturing environmental audio signals and analyzing them for noise levels, speech patterns, and unauthorized device characteristics. The randomizer generates nonsensical phoneme-like data to disrupt voice recognition systems, and the masking signal is dynamically adjusted to environmental changes. The system leverages inaudible frequency shifting to ensure that the masking signal is inaudible to humans but disruptive to devices. Feedback mechanisms refine the masking signal in real-time, while environmental profiles stored in local memory facilitate rapid deployment in similar scenarios. The system also incorporates a calibration module for ongoing optimization, ensuring robust performance against evolving audio capture technologies.

FIG. 3 demonstrates the seamless integration of advanced signal processing, adaptive algorithms, and localized data management to provide a comprehensive and effective solution for audio privacy. The system ensures that unauthorized audio capture is neutralized across diverse scenarios while maintaining user privacy and operational efficiency. The sequence of operations underscores the system's scalability, adaptability, and technological sophistication in addressing modern audio privacy challenges.

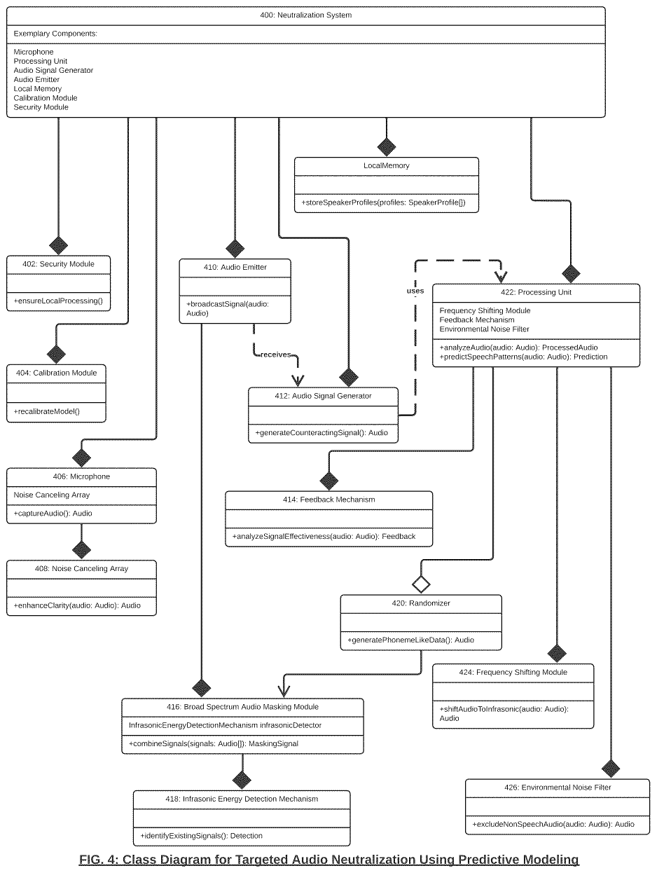

FIG. 4 depicts a comprehensive class diagram for the targeted audio neutralization system, which employs predictive modeling to safeguard verbal communications from unauthorized capture. This system is structured around multiple interconnected components, each designed to fulfill a specific function in the neutralization process, and integrates advanced methodologies to ensure precise operation and adaptability in diverse environments. At the center of the system is the processing unit, labeled 422, which performs essential analytical tasks, including isolating the target speaker's voice, predicting subsequent speech patterns, and generating counteracting audio signals. This unit operates in tandem with other modules, ensuring real-time synchronization and seamless integration of system functionalities.

The microphone, labeled 406, captures audio signals from the environment, including speech and ambient noise, and transmits these signals to the processing unit. The microphone is enhanced with noise-canceling capabilities, enabling it to focus on relevant audio data while excluding extraneous sounds. This ensures that the captured audio is of high quality and suitable for subsequent analysis. Once the audio signals are processed, the system utilizes the audio signal generator, labeled 412, to create counteracting signals. These signals are precisely tuned to neutralize the target speaker's voice by generating an inverted phase signal that cancels the original speech at the point of detection. The generator dynamically adjusts its output based on the input from predictive modeling and real-time feedback mechanisms.

The audio emitter, labeled 410, broadcasts the generated signals into the environment, ensuring that the target speaker's voice is rendered unintelligible to unauthorized devices. The emitter employs directional precision, targeting high-risk areas where unauthorized devices are detected or suspected, and also provides wide-area coverage to ensure comprehensive protection. Local memory, labeled 420, stores speaker profiles and environmental audio profiles, allowing the system to quickly recognize and adapt to previously encountered voices or settings. This stored data facilitates rapid deployment and reduces the need for recalibration, enhancing the system's usability and efficiency.

The calibration module, labeled 404, plays a pivotal role in optimizing system performance. During initialization or when environmental conditions change, the module recalibrates the system to align with the unique characteristics of the target speaker's voice and the surrounding audio environment. This recalibration ensures that the counteracting signals remain effective despite fluctuations in voice characteristics or ambient noise levels. The security module, labeled 402, ensures that all processing and data storage occur locally within the device, safeguarding sensitive information from unauthorized access and maintaining user privacy.

The frequency-shifting module, labeled 424, converts the generated counteracting signals into the inaudible range. This frequency range is inaudible to humans but remains detectable and disruptive to unauthorized audio capture devices. By operating in this range, the system ensures that the counteracting signals do not interfere with the natural auditory experience of individuals in the environment. The feedback mechanism, labeled 414, continuously monitors the effectiveness of the emitted signals, analyzing residual intelligibility and iteratively refining the signal parameters to ensure optimal performance.

Additionally, the system includes an environmental noise filter, labeled 426, which excludes irrelevant non-speech sounds from the analysis and signal generation processes. This feature allows the system to focus its resources on speech-specific signals, improving efficiency and effectiveness. The randomizer, labeled 420, generates phoneme-like data that mimics human speech in tone, pitch, and cadence but lacks coherent linguistic meaning. This random data is used in conjunction with the predictive outputs from the processing unit to create a hybrid masking signal that neutralizes intelligible audio in the environment.

The system's modular design allows for dynamic adaptability and integration with existing audio frameworks. For example, the processing unit leverages machine learning algorithms to predict the target speaker's likely next words or phrases, based on linguistic patterns, speech contexts, and regional accents. This predictive capability enables the system to generate counteracting signals in real time, maintaining seamless operation without perceptible latency. By combining predictive modeling, frequency shifting, and dynamic signal generation, the system achieves a robust and versatile solution for audio privacy, capable of neutralizing unauthorized capture in diverse and high-risk environments.

FIG. 4 showcases the intricate interplay between these components, illustrating how the system integrates advanced signal processing techniques and machine learning to deliver unparalleled privacy protection. This detailed architecture highlights the system's ability to adapt dynamically to changing conditions, ensuring consistent and reliable performance across various scenarios. By leveraging cutting-edge technologies and maintaining a user-centric design, the system addresses critical privacy concerns in environments where unauthorized audio capture poses a significant threat.

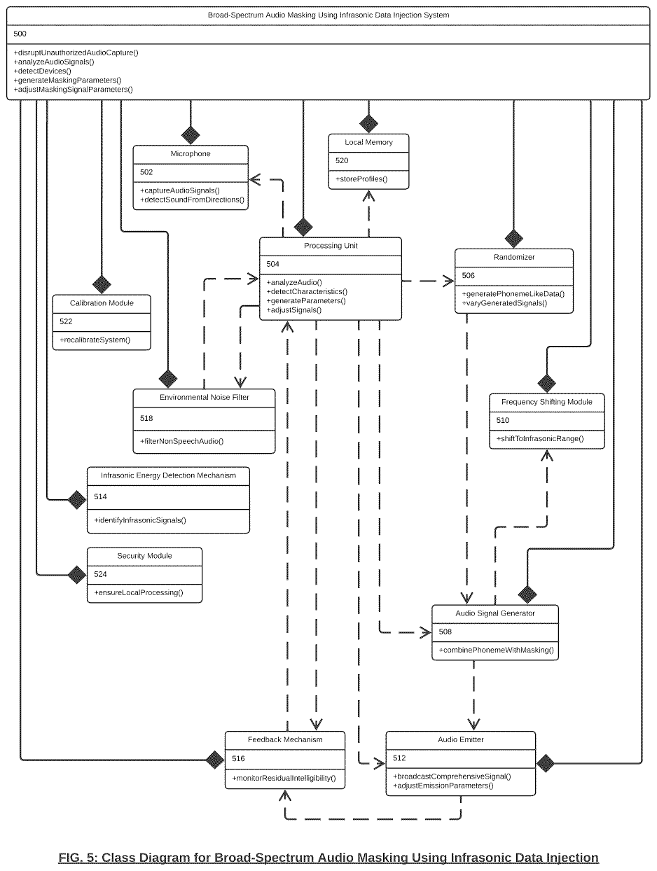

FIG. 5 illustrates a highly detailed class diagram for a broad-spectrum audio masking system that uses inaudible data injection to create an environment hostile to unauthorized audio capture. This system is meticulously designed to generate and emit signals that disrupt the intelligibility of speech and other sounds, preventing devices from recording or processing meaningful data. At the core of the system is the processing unit, labeled 504, which is the analytical engine responsible for interpreting captured audio signals, detecting unauthorized devices, and generating parameters for the masking signals. This component works in conjunction with the other modules to ensure that the emitted signals are effective, precise, and dynamically adaptive to the conditions of the environment.

The system's operation begins with the microphone, labeled 502, which captures audio signals from the surrounding environment. The microphone is equipped with advanced directional sensors that isolate relevant sounds, such as speech, while filtering out non-essential noise. This capability allows the system to focus its resources on identifying and neutralizing potential threats. The captured audio signals are sent to the processing unit, where they are analyzed to detect background noise, unauthorized devices, and other relevant audio sources. This analysis involves breaking down the audio into its frequency components, identifying patterns, and classifying the characteristics of the sound to inform the next stages of the process.

A critical component of the system is the randomizer, labeled 506, which generates complex phoneme-like data that mimics the structural qualities of human speech but lacks any coherent linguistic meaning. This random data is unpredictable and continuously varied, making it particularly effective at overwhelming voice recognition algorithms. The audio signal generator, labeled 508, integrates the randomizer's output with additional masking parameters to create comprehensive masking signals. These signals are tailored to disrupt the operation of unauthorized audio capture devices, ensuring that they cannot isolate or process intelligible audio. The audio signal generator dynamically adjusts the generated signals to accommodate changes in the environment, such as variations in background noise levels or the detection of new audio sources.

The frequency-shifting module, labeled 510, processes the generated signals by converting them from the normal human speech frequency range, typically between 90 Hz and 255 Hz, into the inaudible range. This frequency shift ensures that the masking signals are inaudible to humans but remain highly disruptive to unauthorized devices, which rely on microphones and audio processing algorithms capable of detecting inaudible frequencies. By operating in this range, the system avoids interfering with human auditory experiences while still achieving its disruptive objectives. The frequency-shifting module continuously adapts the signal parameters to counteract a broad range of device sensitivities, further enhancing the system's versatility and effectiveness.

The audio emitter, labeled 512, broadcasts the processed masking signals into the environment. The emitter employs beamforming technology to direct the signals with high precision toward areas where unauthorized devices are detected or suspected. In addition to targeted precision, the emitter provides wide-area coverage to ensure that even hidden or undetected devices are neutralized. The emitted signals disrupt the ability of voice-enabled devices to capture intelligible audio, effectively rendering conversations and other sounds unintelligible.

The system incorporates a feedback mechanism, labeled 516, to monitor the effectiveness of the emitted signals. This mechanism continuously evaluates the residual intelligibility of the audio environment, analyzing whether unauthorized devices could still process meaningful data. Based on this analysis, the system iteratively refines the signal parameters, including amplitude, frequency, and phase, to optimize the disruptive effect. This real-time adjustment capability allows the system to adapt dynamically to changing conditions, ensuring consistent performance in diverse and complex environments.

An additional component, the inaudible energy detection mechanism labeled 514, identifies existing inaudible signals within the environment. This feature prevents the system from interfering with legitimate uses of the inaudible spectrum, such as industrial applications or other devices. By detecting and avoiding these frequencies, the system ensures that its operation does not disrupt authorized activities while maintaining its effectiveness against unauthorized devices.

Local memory, labeled 520, plays a vital role in storing environmental profiles and calibration data. These stored profiles allow the system to quickly adapt to previously encountered conditions or settings, reducing setup time and enhancing operational efficiency. The calibration module, labeled 522, ensures that the system remains optimized for performance. During initialization or when environmental conditions change, the calibration module recalibrates the system's components to maintain accurate and effective masking. This process ensures that the system's output is tailored to the specific characteristics of the environment and the detected threats.

The environmental noise filter, labeled 518, excludes irrelevant non-speech sounds, such as mechanical noise or background music, from the masking signal generation process. This targeted approach improves the system's efficiency by focusing its resources on disrupting speech-specific audio signals, which are more likely to be of interest to unauthorized devices. The security module, labeled 524, guarantees that all signal processing, data analysis, and storage occur locally within the device. This localized operation safeguards user privacy, ensuring that no sensitive data is transmitted or exposed to external threats.

The system's modular architecture allows for seamless integration and dynamic adaptability. Each component is designed to interact with the others in a way that maximizes the effectiveness of the masking signals while minimizing interference with legitimate activities. The combination of randomization, frequency shifting, feedback-driven refinement, and advanced signal processing techniques creates a robust and versatile solution to the growing threat of unauthorized audio capture. FIG. 5 exemplifies the system's capability to provide comprehensive audio privacy protection in environments where voice-enabled devices are prevalent and privacy concerns are paramount. By leveraging state-of-the-art technologies, this system ensures that conversations and other audio sources remain secure from eavesdropping and unauthorized recording.

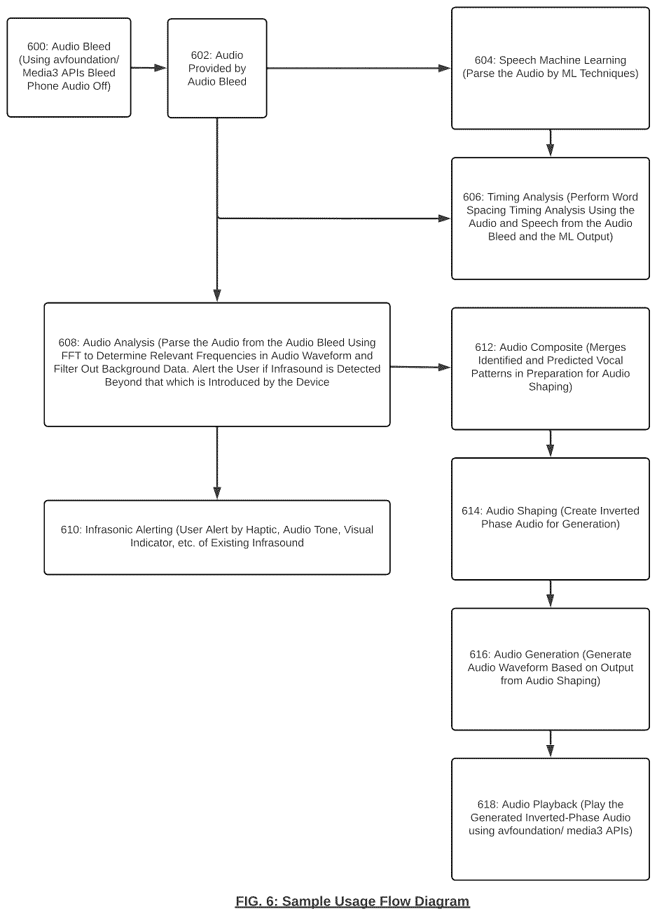

FIG. 6 illustrates a detailed usage flow diagram for the system, showcasing the intricate steps involved in processing audio data to generate and emit signals that neutralize unauthorized audio capture. The flow begins with step 600, labeled as “Audio Bleed,” where audio from a device is captured using advanced APIs such as avfoundation or Media3. This audio bleed serves as the foundational input for the system, enabling the subsequent analysis and processing stages. At step 602, the audio bleed data is further analyzed to detect its characteristics and prepare it for processing. This stage ensures that the audio is ready for the application of machine learning and signal manipulation techniques.

At step 604, the system employs machine learning algorithms to parse the captured audio, identifying speech patterns and other relevant data. The machine learning analysis isolates spoken words, detects timing, and recognizes linguistic structures, forming a predictive basis for subsequent operations. This predictive capability is essential for real-time audio shaping, as it allows the system to anticipate vocal patterns and align its countermeasures effectively. Step 606 involves timing analysis, where the system examines the rhythm and spacing of words within the speech. This analysis helps synchronize the audio countermeasures with the natural cadence of the speaker's voice, ensuring precise alignment and maximizing the disruption of unauthorized audio capture.

In step 608, the system performs an audio analysis using a Fast Fourier Transform (FFT) to dissect the audio waveform into its frequency components. This spectral analysis identifies relevant frequencies, particularly those associated with speech, and filters out background noise and irrelevant data. FFT analysis also detects infrasound that exceeds the thresholds introduced by the device itself. If infrasound is detected beyond expected levels, the system alerts the user through haptic feedback, audio tones, or visual indicators, as shown in step 610, labeled as “Inaudible Alerting.” This feature enhances the user's awareness of potential unauthorized audio capture attempts by highlighting environmental anomalies.

At step 612, the system merges identified and predicted vocal patterns into a cohesive dataset, preparing the audio for shaping. This audio composite serves as the basis for generating a masking signal that neutralizes the intelligibility of speech to unauthorized devices. Step 614, labeled as “Audio Shaping,” involves creating an inverted-phase audio signal tailored to disrupt the detected speech patterns. The system dynamically adjusts the shape and parameters of the signal based on the analysis results and real-time environmental feedback. This ensures that the generated signal effectively counteracts the captured audio without introducing unintended interference.

In step 616, the audio shaping results are used to generate the final audio waveform. This waveform is carefully crafted to include inverted-phase components and frequency shifts, rendering it disruptive to audio capture systems while remaining imperceptible to humans. The generated waveform is then broadcast in step 618, labeled as “Audio Playback,” using APIs like avfoundation or Media3. The system transmits the audio through compatible output devices, ensuring comprehensive coverage and precision targeting of unauthorized capture threats.

Throughout this process, the system dynamically adapts to changes in the environment, such as variations in noise levels, new audio sources, or additional unauthorized devices. The combination of advanced machine learning, timing analysis, spectral processing, and real-time adaptation ensures that the system delivers a robust and effective solution to the growing threat of unauthorized audio capture. FIG. 6 highlights the meticulous interplay of these components and processes, demonstrating the system's capability to operate seamlessly in diverse and complex audio environments while safeguarding user privacy. The detailed flow illustrates the innovative integration of predictive modeling, infrasound detection, and signal generation, emphasizing the sophistication and adaptability of the invention.

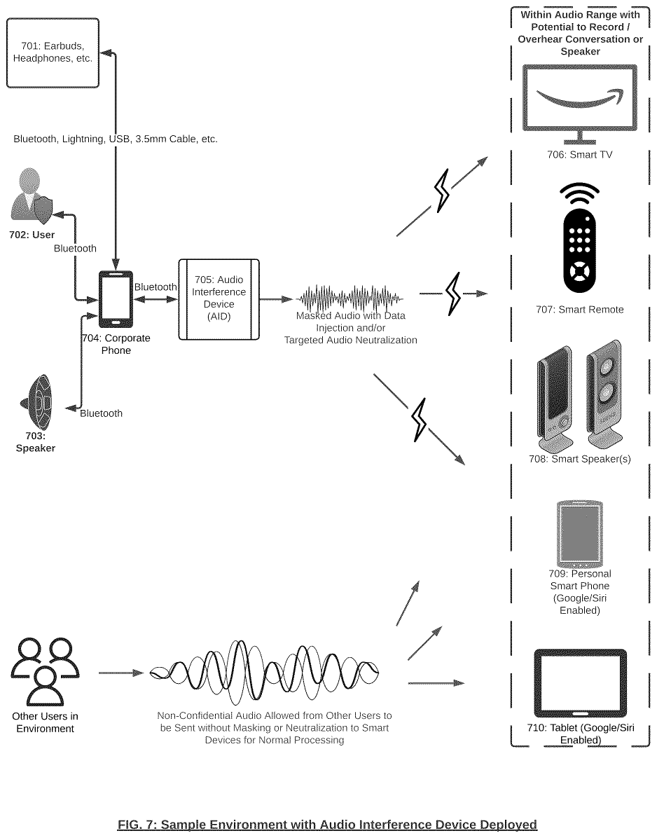

FIG. 7 provides a comprehensive depiction of an Audio Interference Device (AID), labeled 705, deployed within a technologically advanced environment populated with multiple voice-enabled devices. These devices include a corporate phone, labeled 704, and other potential audio capture devices such as smart TVs, labeled 706, smart remotes, labeled 707, smart speakers, labeled 708, personal smartphones enabled with voice assistants like Siri or Google Assistant, labeled 709, and tablets with similar capabilities, labeled 710. The AID is designed to protect the privacy of verbal communications by generating audio signals that neutralize the ability of these devices to capture, process, or record meaningful speech from the end user, labeled 702. The figure demonstrates how the AID integrates seamlessly into a typical user environment, ensuring privacy without disrupting normal usage patterns.

The end user interacts with the corporate phone in various ways, including through the use of earbuds or headphones, labeled 701, via the loudspeaker of the phone, labeled 703, or directly by speaking into the device. These interactions are intended to proceed as they normally would, with the AID functioning in the background to create an audio barrier against unauthorized capture. The AID operates by intercepting the user's voice from any input source and producing a soundscape that masks it effectively. This masking soundscape is generated in real time and tailored to the specific audio characteristics of the environment, ensuring that no intelligible speech is available for unauthorized devices to process or record.

The AID requires the installation of a dedicated software package on the corporate phone, providing the necessary interface and controls to enable its operation. The device is capable of connecting to the phone either wirelessly, using Bluetooth, or through physical means such as a USB or 3.5 mm cable. The effectiveness of the AID is dependent on the quality of this connection. For wireless connections, the operational range is dictated by the Bluetooth capabilities of the devices, while for physical connections, the performance is influenced by the level of acceptable noise over the connection medium. This dual-mode connectivity ensures that the AID can be deployed flexibly across different setups and use cases, adapting to both wireless and wired environments.

The AID takes the user's voice input from devices such as earbuds, loudspeakers, or the corporate phone itself and generates a corresponding soundscape that masks the voice. This masking is achieved through advanced signal processing techniques, where the AID generates signals that overlap and neutralize the user's voice, rendering it unintelligible to unauthorized devices in the vicinity. The soundscape is meticulously engineered to remain imperceptible to human listeners while being disruptive to the microphones and audio processing algorithms used by devices like smart TVs, smart remotes, or smart speakers. The AID ensures comprehensive coverage, extending its protective effects to all voice-enabled devices within its operational range, including those not directly visible to the user.

A key feature of the AID is its ability to learn and adapt to the primary end user's vocal patterns over time. The device samples the user's voice during interactions, capturing unique characteristics such as pitch, tone, cadence, and inflection. This data is used to build a detailed vocal profile, enabling the AID to predict and generate interference signals with greater accuracy. By continuously refining its understanding of the user's speech patterns, the AID ensures that its masking signals are optimally aligned with the user's voice, even as speech patterns change due to variations in tone, volume, or cadence. This predictive capability enhances the effectiveness of the AID, ensuring real-time responsiveness to the user's speech and environmental conditions.

The AID itself can take many forms, provided it possesses the ability to produce audio frequencies, pair with a phone or other voice-driven interface via Bluetooth, and include a microphone or equivalent audio input device. This versatility allows the AID to be integrated into various physical formats, from standalone devices to accessories like phone cases or desktop units. Regardless of its form, the AID operates by sampling the primary user's voice, analyzing the captured audio, and generating a corresponding soundscape designed to mask that voice from all potential eavesdropping devices in the environment. The generated soundscape not only neutralizes unauthorized capture but also prevents the devices from detecting the presence of intelligible speech altogether.

FIG. 7 highlights the sophisticated interplay between the AID and the surrounding environment, emphasizing the device's ability to safeguard verbal communications in real time. The system dynamically adapts to changing conditions, such as the addition of new audio sources or variations in background noise, ensuring consistent and reliable performance. This figure encapsulates the innovative design of the AID, demonstrating its capacity to address privacy concerns in environments where voice-enabled devices are pervasive. By leveraging advanced signal processing, adaptive learning, and real-time soundscape generation, the AID provides a robust solution for protecting verbal communications against unauthorized audio capture, ensuring user privacy in even the most complex and high-risk scenarios.
Pseudocode exemplars for implementing various aspects of this disclosure are set forth below with explanations for reference.
Initialize system
Microphone.configureDirectionalCapture( )
ProcessingUnit.initializeModules( )
AudioSignalGenerator.initializeSettings( )
FrequencyShiftingModule.configureFrequencyRange(Inaudible)
FeedbackMechanism.setupMonitoring( )
LocalMemory.loadUserProfiles( )
CalibrationModule.initializeDefaults( )
SecurityModule.ensureLocalProcessing( )
EnvironmentalNoiseFilter.configureFilterSettings( )
Start main loop
Capture environmental audio
RawAudio=Microphone.captureAudio( )
Timestamp=System.getCurrentTime( )
Analyze captured audio
SpeechData=ProcessingUnit.analyzeAudio(RawAudio)
TimingData=ProcessingUnit.detectSpeechTiming(SpeechData)
FrequencyData=ProcessingUnit.performFFT(RawAudio)
NoiseCharacteristics=EnvironmentalNoiseFilter.filterNonSpeechAudio(RawAudio)
Check for inaudible energy
InfrasoundSignals=InaudibleEnergyDetectionMechanism.identifyInaudibleSignals(FrequencyData)
If InfrasoundSignals:
UserNotifier.alert(“Infrasound detected”, Method=“haptic”)
Predict speech patterns
PredictedSpeech=ProcessingUnit.predictSpeechPatterns(SpeechData)
Generate masking signals
MaskingParameters=ProcessingUnit.generateMaskingParameters(SpeechData, NoiseCharacteristics)
MaskingSignal=Randomizer.generatePhonemeLikeData(MaskingParameters)
CompositeSignal=SignalGenerator.combinePhonemeWithMasking(MaskingSignal)
Adjust masking signal for emission
ShiftedSignal=FrequencyShiftingModule.shiftToInaudible(CompositeSignal)
FinalSignal=AudioShapingModule.createInvertedPhase(ShiftedSignal)
Emit audio masking signal
AudioEmitter.broadcastSignal(FinalSignal)
Monitor signal effectiveness
ResidualIntelligibility=FeedbackMechanism.analyzeSignalEffectiveness(FinalSignal)
If ResidualIntelligibility>Threshold:
FeedbackMechanism.adjustEmissionParameters( )
CalibrationModule.recalibrateModel( )
Update system knowledge
LocalMemory.storeProfiles(UserProfile, EnvironmentalAudioProfile)
SecurityModule.logActivity(Timestamp, SignalMetadata)
Sleep for processing delay
End main loop

The pseudocode begins with an initialization phase that configures all major components of the system. The microphone is configured for directional and high-fidelity audio capture, ensuring the system can isolate relevant sounds such as speech while excluding extraneous noise. The processing unit initializes its submodules, including those responsible for audio analysis, predictive modeling, and signal generation. The frequency-shifting module is calibrated to operate in the inaudible range, ensuring that generated masking signals are inaudible to humans but disruptive to unauthorized devices. Feedback mechanisms are set up to continuously monitor the effectiveness of emitted signals and adjust system parameters as needed. Local memory loads user and environmental profiles to facilitate rapid deployment and adaptation to previously encountered conditions. The calibration module establishes default settings for optimal performance, and the security module ensures that all processing and data storage occur locally, safeguarding privacy.

In the main loop, the microphone captures environmental audio, which is time-stamped for synchronization and sent to the processing unit for analysis. The captured audio is broken down into several components: speech data is extracted using speech recognition algorithms, timing data is derived to identify speech cadence and rhythm, and frequency data is generated through a Fast Fourier Transform (FFT) to analyze the spectral properties of the audio. The environmental noise filter removes non-speech sounds such as background music or mechanical noise, optimizing the focus of the system on relevant audio signals.

The processing unit detects inaudible signals using the inaudible energy detection mechanism, which scans the frequency data for patterns indicative of unauthorized devices. If inaudible energy is detected, the system alerts the user via haptic feedback or another user-selected notification method. This feature ensures that users are informed of potential threats in their environment.

Speech data is further processed by the predictive modeling component, which anticipates the user's next words or phrases based on linguistic patterns, timing data, and contextual analysis. These predictions are used to prepare masking signals in advance, minimizing latency and ensuring real-time operation. The processing unit generates masking parameters, which are fed into the randomizer to produce phoneme-like data that mimics human speech in structure but lacks coherence. The signal generator combines this data with additional masking parameters to create a composite signal designed to disrupt the functionality of voice-enabled devices.

The frequency-shifting module processes the composite signal by converting it into the inaudible range. This frequency shift ensures the signal is imperceptible to humans while remaining disruptive to devices that rely on audio capture and processing. The audio shaping module further enhances the signal by creating an inverted-phase component that neutralizes the user's speech at the point of capture. The final signal is then broadcast by the audio emitter, which employs beamforming technology to target high-risk areas while also providing wide-area coverage.

The system continuously monitors the effectiveness of the emitted signals using the feedback mechanism, which evaluates residual intelligibility in the environment. If unauthorized devices can still process audio, the feedback mechanism dynamically adjusts signal parameters, such as frequency, phase, and amplitude. The calibration module recalibrates the system as needed to maintain optimal performance. User and environmental profiles are updated in local memory to improve predictive accuracy and reduce setup time for future interactions. The security module logs system activity, ensuring that all actions are documented for accountability and troubleshooting.

This detailed pseudocode integrates the functionalities from FIG. 4 and FIG. 5, including modules such as the randomizer, environmental noise filter, feedback mechanism, and inaudible energy detection. Each function is designed to interact seamlessly with the others, creating a robust system capable of addressing the challenges of unauthorized audio capture in real time. By leveraging advanced signal processing techniques, machine learning, and adaptive feedback, the system ensures comprehensive privacy protection in diverse and high-risk environments.

A skilled artisan, upon reviewing the disclosure, will appreciate that there are numerous alternatives, modifications, combinations, and customizations that can be made to the systems and methods described herein. In particular, the systems and methods described herein for targeted audio neutralization using predictive modeling and broad-spectrum audio masking using inaudible data injection can be expanded, modified, combined, or customized in various ways to enhance their applicability, functionality, or deployment in diverse scenarios. These alternatives, modifications, combinations, and customizations are within the spirit and scope of the disclosure and aim to extend its versatility and impact. Below is a detailed enumeration of potential adaptations:
a. Integration with Other Technologies: The systems can be integrated with existing audio processing frameworks, such as those used in smartphones, conferencing systems, and public address systems. For example, the Audio Interference Device (AID) could utilize APIs like avfoundation or Media3 to leverage built-in hardware for enhanced performance.
b. Hardware Configurations: The AID can be implemented in various physical forms, including standalone units, embedded systems within smartphones, or wearable devices like smartwatches or earpieces. It can also be built into communication devices, such as teleconferencing equipment or enterprise-grade phones, to provide built-in privacy features.
c. Alternative Communication Protocols: While Bluetooth and wired connections are central to the current implementation, other communication protocols like Wi-Fi, Zigbee, or ultra-wideband (UWB) could be employed to enhance connectivity and range. These protocols may enable multi-device coordination, allowing several AIDs to function collaboratively in large environments.
d. Advanced Signal Generation Techniques: The system could incorporate alternative signal generation methods, such as dynamically adjusting harmonic structures or introducing chaotic masking patterns. This modification could enhance the disruption of sophisticated audio capture devices that rely on adaptive machine learning algorithms.
e. Environmental Adaptation: The systems could be customized to account for specific environmental conditions, such as open spaces, soundproof rooms, or outdoor settings. For instance, beamforming algorithms can be refined to focus on specific zones or directions, ensuring effective coverage while conserving energy.
f. Dynamic Profiles: User profiles stored in local memory could be enhanced to include multi-user configurations, allowing the system to adapt to different speakers in a shared environment. This feature would make the system ideal for multi-user conference rooms or family households.
g. Modifications to Masking Frequency Ranges: The masking signals can be shifted not only into the inaudible range but also into the ultrasonic range, depending on the types of devices being targeted. This flexibility ensures that the system remains effective against a wider array of microphones and sensors.
h. Machine Learning Customizations: The machine learning models used for predictive speech analysis can be trained on domain-specific data to enhance their performance in specialized environments, such as legal discussions or technical meetings. These models could also be updated periodically to account for evolving speech patterns and languages.
i. Enhanced Feedback Mechanisms: The feedback loop can be augmented with additional sensors, such as environmental microphones or vibration sensors, to provide more granular data on the effectiveness of the masking signals. This would improve real-time adjustments and enhance overall system performance.
j. Multi-Device Synchronization: In scenarios involving multiple AIDs deployed across a large area, synchronization mechanisms could be implemented to ensure consistent masking coverage. This could involve real-time communication between devices to coordinate signal generation and emission.
k. Energy Efficiency Enhancements: Modifications to the system could include energy-saving modes, where the intensity and frequency of masking signals are adjusted based on ambient noise levels or detected device activity. Solar-powered or battery-optimized versions could be developed for portable use.
l. Regulatory Compliance and Spectrum Management: The system could include a spectrum management module to ensure compliance with local and international regulations governing inaudible and ultrasonic emissions. This module could dynamically adapt the masking signals to avoid interfering with legitimate uses of these frequency ranges.
m. Alternative Deployment Scenarios: The system can be deployed in secure environments such as government facilities, financial institutions, or other settings. Customizations can include integration with access control systems or conference room management software to activate the AID only during sensitive discussions.
n. Combination of Targeted and Broad-Spectrum Masking: The two methods described (targeted neutralization and broad-spectrum masking) can be combined to create a hybrid system. Such a system would provide layered security, targeting specific voices while masking the entire environment for comprehensive protection.
o. Custom User Interfaces: A user-friendly interface could be developed for managing the system, enabling users to customize signal parameters, activate or deactivate specific functionalities, and monitor system performance in real time.
p. IoT Integration: The system can be integrated into Internet of Things (IoT) ecosystems, allowing remote control and monitoring via smartphones or centralized management platforms. This integration could extend to smart homes, offices, or industrial settings.
q. Use of Enhanced Sensors: In addition to standard microphones, advanced sensors such as laser microphones or contact microphones could be incorporated to detect vibrations or sound waves through surfaces, further enhancing the system's capabilities.
r. Custom Signal Modulation: Masking signals could include amplitude modulation, frequency modulation, or phase-shift keying to disrupt specific audio capture techniques employed by unauthorized devices.
s. Privacy Assurance for Specific Devices: The system could be customized to interact with trusted devices, ensuring that the masking signals do not disrupt communication with authorized systems while targeting only unauthorized or untrusted devices.
t. Integration with Security Systems: The AID could be integrated into broader security systems, including surveillance systems or intrusion detection systems, to enhance overall environmental security.
u. Combination with Acoustic Masking Materials: The system could be used in conjunction with soundproofing materials or acoustic panels to enhance its effectiveness in static environments, such as conference rooms or recording studios.

These alternatives, modifications, combinations, and customizations reflect the flexibility and extensibility of the described systems and methods. They provide opportunities for addressing a wide array of use cases, from personal privacy protection to enterprise-level security, while staying within the scope of the disclosure.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method of preventing unauthorized audio capture by neutralizing electronic personal digital assistants, comprising:
capturing audio signals from an environment using a microphone
configured to detect ambient audio within a predefined range;
analyzing the captured audio signals using a processing unit to isolate speech patterns associated with a target speaker based on unique vocal characteristics, including pitch, tone, cadence, and frequency patterns;
predicting, by a machine learning model implemented in the processing unit, subsequent words or phrases likely to be spoken by the target speaker, the prediction being based on the speech patterns and contextual data;
generating, using an audio signal generator operably connected to the processing unit, a counteracting audio signal that is 180 degrees out of phase with the speech of the target speaker, the counteracting audio signal being configured to neutralize the target speaker's voice at point of detection by the electronic personal digital assistants;
frequency-shifting, by the processing unit, the counteracting audio signal into an inaudible range, such that the signal is inaudible to humans but detectable by unauthorized audio capture devices;
synchronizing, by the processing unit, timing of the counteracting audio signal with a target speaker's speech cadence to ensure real-time neutralization without perceptible delay;
broadcasting, using an audio emitter operably connected to the audio signal generator, the counteracting audio signal into the environment to render the target speaker's voice unintelligible to unauthorized audio capture devices;
adapting, by the processing unit, the counteracting audio signal dynamically in response to changes in a target speaker's voice characteristics or environmental audio conditions, including variations in tone, volume, and background noise; and
storing, in a local memory accessible to the processing unit, data representing the target speaker's voice characteristics for use in subsequent operations of the method, wherein the stored data facilitates faster identification and neutralization of the target speaker's voice in future interactions.

2. The method of claim 1, wherein the microphone is configured to capture audio signals within a 360-degree range, employing multiple directional sensors to detect the target speaker's voice regardless of their position relative to the microphone or presence of physical barriers.

3. The method of claim 2, wherein the processing unit employs a Fast Fourier Transform (FFT) to analyze frequency components of the captured audio signals, using a frequency-domain filtering technique to isolate the target speaker's voice from overlapping background noise, echoes, and ambient sounds.

4. The method of claim 3, wherein the machine learning model is pre-trained on a dataset comprising varied linguistic patterns, regional accents, and common speech anomalies, enabling accurate prediction of subsequent words or phrases spoken by the target speaker under diverse conversational contexts.

5. The method of claim 4, wherein the machine learning model further incorporates contextual analysis by identifying semantic and syntactic relationships within captured speech, leveraging a natural language processing (NLP) framework to refine the prediction of likely future phrases.

6. The method of claim 5, wherein the processing unit generates the counteracting audio signal by applying an adaptive phase-inversion algorithm that accounts for fluctuations in pitch, amplitude, and inflection in the target speaker's vocal characteristics, ensuring effective cancellation even during dynamic speech patterns.

7. The method of claim 6, wherein the counteracting audio signal is generated in multiple overlapping frequency bands, each tailored to neutralize distinct components of the target speaker's vocal range, including fundamental frequencies and harmonics.

8. The method of claim 7, wherein the processing unit implements a frequency modulation algorithm to adjust the inaudible counteracting audio signal dynamically in response to a detected spectral profile of a target speaker's speech, maintaining its efficacy against unauthorized devices equipped with adaptive noise cancellation technologies.

9. The method of claim 8, wherein the synchronization of the counteracting audio signal is achieved by continuously monitoring the target speaker's speech cadence and applying a predictive timing adjustment algorithm that pre-aligns a signal's emission with anticipated speech segments.

10. The method of claim 9, wherein the audio emitter is configured to emit the counteracting audio signal with directional precision, using beamforming technology to target specific zones in the environment while minimizing unintended interference with authorized audio devices or nearby conversations.

11. The method of claim 10, wherein the processing unit includes a real-time feedback mechanism that continuously analyzes the effectiveness of the counteracting audio signal by detecting residual intelligibility of the target speaker's voice in captured audio, and iteratively adjusts the signal's amplitude, frequency, and phase to optimize neutralization.

12. The method of claim 11, wherein the local memory stores multiple profiles of individual speakers, each including a unique set of vocal characteristics, enabling a system to neutralize the voices of multiple target speakers simultaneously by generating and emitting individualized counteracting audio signals for each profile.

13. The method of claim 12, wherein the processing unit incorporates an advanced environmental noise filter that identifies and excludes non-speech audio, such as mechanical sounds or background music, from the analysis and neutralization process to enhance system precision and performance.

14. The method of claim 13, wherein the processing unit periodically recalibrates the machine learning model based on updated voice data collected from the target speaker, incorporating long-term voice changes, contextual shifts, and environmental conditions to improve the system's predictive accuracy and adaptability over extended use.

15. A method of preventing unauthorized audio capture by neutralizing electronic personal digital assistants, comprising:
capturing audio signals from an environment using a microphone
configured to detect ambient audio within a 360-degree range and employing multiple directional sensors to detect the target speaker's voice regardless of their position relative to the microphone or presence of physical barriers;
analyzing the captured audio signals using a processing unit that employs a Fast Fourier Transform (FFT) to isolate frequency components of the target speaker's voice from overlapping background noise, echoes, and ambient sounds using frequency-domain filtering techniques;
identifying, by the processing unit, unique vocal characteristics of the target speaker, including pitch, tone, cadence, and frequency patterns, to isolate and track their speech in presence of other audio sources;
predicting, by a machine learning model implemented in the processing unit, subsequent words or phrases likely to be spoken by the target speaker, the prediction being based on the speech patterns, contextual relationships identified using a natural language processing framework, and pre-trained datasets comprising varied linguistic patterns, regional accents, and common speech anomalies;
generating, using an audio signal generator operably connected to the processing unit, a counteracting audio signal that is:
(i) 180 degrees out of phase with the speech of the target speaker to neutralize the target speaker's voice at point of detection by unauthorized audio capture devices;
(ii) dynamically adjusted to account for fluctuations in pitch, amplitude, and inflection in the target speaker's vocal characteristics; and
(iii) configured to cover multiple overlapping frequency bands to neutralize distinct components of the target speaker's vocal range, including fundamental frequencies and harmonics;
frequency-shifting, by the processing unit, the counteracting audio signal into an inaudible range, ensuring that the signal is inaudible to humans but detectable by unauthorized audio capture devices;
generating, using a randomizer operably connected to the processing unit, phoneme-like data or nonsensical audio signals that mimic human speech in tone, pitch, and cadence but lack coherent linguistic meaning, the generated signals being dynamically varied to ensure unpredictability and disrupt voice recognition systems;
combining, by a broad-spectrum audio masking module integrated into the processing unit, the counteracting audio signal with the phoneme-like data generated by the randomizer to create a comprehensive masking signal that neutralizes both targeted and broad-spectrum audio within the environment;
synchronizing, by the processing unit, timing of the combined masking signal with a target speaker's speech cadence using a predictive timing adjustment algorithm to pre-align a signal's emission with anticipated speech segments, ensuring real-time neutralization without perceptible delay;
broadcasting, using an audio emitter operably connected to the audio signal generator, the combined masking signal into the environment with both directional precision, using beamforming technology to target specific zones, and wide-area coverage to ensure comprehensive disruption of unauthorized audio capture devices across the operational range of the system;
adapting, by the processing unit, the combined masking signal dynamically in response to changes in a target speaker's voice characteristics, ambient noise levels, and presence of unauthorized audio capture devices, including variations in tone, volume, and background noise;
detecting, by an inaudible energy detection mechanism integrated into the processing unit, existing inaudible signals in the environment and adjusting the combined masking signal to avoid conflicts with legitimate uses of an inaudible frequency spectrum;
storing, in a local memory accessible to the processing unit, multiple profiles of individual speakers, each profile comprising a unique set of vocal characteristics, enabling the system to neutralize the voices of multiple target speakers simultaneously by generating and emitting individualized counteracting audio signals for each profile;
incorporating, by the processing unit, an advanced environmental noise filter to identify and exclude non-speech audio, including mechanical sounds and background music, from the analysis and neutralization process to enhance system precision and performance;
periodically recalibrating, by the processing unit, the machine learning model based on updated voice data collected from the target speaker, accounting for long-term voice changes, contextual shifts, and environmental conditions to improve predictive accuracy and adaptability over extended use; and
maintaining, by the system, all signal generation, analysis, and
neutralization processes locally on the device, ensuring that no sensitive audio data is transmitted or stored externally, thereby safeguarding user privacy and data security.

16. A system preventing unauthorized audio capture by neutralizing electronic personal digital assistants, comprising:
a microphone configured to capture audio signals from an
environment within a 360-degree range, the microphone employing multiple directional sensors to detect the target speaker's voice regardless of their position relative to the microphone or presence of physical barriers;
a processing unit operably connected to the microphone, the processing unit configured to:
(i) analyze the captured audio signals using a Fast Fourier Transform (FFT) to isolate frequency components of the target speaker's voice from overlapping background noise, echoes, and ambient sounds using frequency-domain filtering techniques;
(ii) identify unique vocal characteristics of the target speaker, including pitch, tone, cadence, and frequency patterns, to isolate and track their speech in presence of other audio sources;
(iii) predict, using a machine learning model, subsequent words or phrases likely to be spoken by the target speaker, the prediction based on analyzed speech patterns, contextual relationships identified using a natural language processing framework, and pre-trained datasets comprising varied linguistic patterns, regional accents, and common speech anomalies; and
(iv) dynamically adapt the system's response to changes in a target speaker's voice characteristics or environmental audio conditions, including variations in tone, volume, and background noise;
an audio signal generator operably connected to the processing unit, the audio signal generator configured to generate a counteracting audio signal that is:
(i) 180 degrees out of phase with the speech of the target
speaker to neutralize the target speaker's voice at point of detection by unauthorized audio capture devices;
(ii) dynamically adjusted to account for fluctuations in pitch, amplitude, and inflection in the target speaker's vocal characteristics; and
(iii) configured to cover multiple overlapping frequency bands to neutralize distinct components of the target speaker's vocal range, including fundamental frequencies and harmonics;
a frequency-shifting module integrated into the processing unit, the module configured to shift the counteracting audio signal into an inaudible range, ensuring that the signal is inaudible to humans but detectable by unauthorized audio capture devices;
an audio emitter operably connected to the audio signal generator, the audio emitter configured to broadcast the counteracting audio signal into the environment with directional precision, using beamforming technology to target specific zones while minimizing interference with authorized audio devices or nearby conversations;
a feedback mechanism integrated into the processing unit, the feedback mechanism configured to continuously analyze effectiveness of the counteracting audio signal by detecting residual intelligibility of the target speaker's voice in captured audio and iteratively adjusting the signal's amplitude, frequency, and phase to optimize neutralization;
a local memory operably connected to the processing unit, the local memory configured to store multiple profiles of individual speakers, each profile comprising a unique set of vocal characteristics, enabling the system to neutralize the voices of multiple target speakers simultaneously by generating and emitting individualized counteracting audio signals for each profile;
an environmental noise filter integrated into the processing unit, the noise filter configured to identify and exclude non-speech audio, including mechanical sounds and background music, from the analysis and neutralization process to enhance system precision and performance;
a calibration module configured to periodically recalibrate the machine learning model based on updated voice data collected from the target speaker, accounting for long-term voice changes, contextual shifts, and environmental conditions to improve predictive accuracy and adaptability over extended use; and
a security module integrated into the system, the security module configured to ensure that all signal generation, analysis, and neutralization processes are performed locally on the device, preventing transmission or storage of sensitive audio data externally and safeguarding user privacy and data security.

17. The system of claim 16, wherein the microphone further comprises a noise-canceling array configured to enhance clarity of the target speaker's voice by suppressing ambient noise, echoes, and overlapping conversations prior to signal processing by the processing unit.

18. The system of claim 17, wherein the machine learning model within the processing unit is configured to perform real-time contextual analysis using a preloaded linguistic database, enabling the prediction of industry-specific or domain-specific terminology in conversations involving the target speaker.

19. The system of claim 18, wherein the audio emitter is configured to dynamically adjust its beamforming parameters to target specific areas within the environment, such as zones near known audio capture devices, while maintaining minimal interference with other areas to ensure optimized masking.

20. The system of claim 19, further comprising:
a randomizer operably connected to the processing unit, the randomizer configured to generate phoneme-like data or nonsensical audio signals that mimic human speech in tone, pitch, and cadence but lack coherent linguistic meaning, the generated signals being dynamically varied to ensure unpredictability and disrupt voice recognition systems;
a broad-spectrum audio masking module integrated into the processing unit, the module configured to:
(i) combine the counteracting audio signals generated by the audio signal generator with the phoneme-like data from the randomizer to create a comprehensive masking signal;
(ii) broadcast the combined masking signal across a wide range of frequencies, including audible and inaudible ranges, to neutralize all audio within the environment regardless of its source; and
(iii) adapt intensity, frequency, and complexity of the masking signal dynamically in response to changes in ambient noise levels and presence of unauthorized audio capture devices;
an inaudible energy detection mechanism integrated into the processing unit, the mechanism configured to identify existing inaudible signals in the environment and adjust the masking signal to avoid conflicts with legitimate uses of an inaudible frequency spectrum; and
wherein the audio emitter is further configured to broadcast the combined masking signal with both directional precision, using beamforming technology, and wide-area coverage, ensuring comprehensive protection against unauthorized audio capture devices across an operational range of the system.
